(19) United States
(12) Patent Application Publication
(10) Pub. No.: US 2019/0133106 A1
(43) Pub. Date: May 9, 2019

(54) INSECT TRAP

(71) Applicant: Seoul Viosys Co., Ltd., Ansan-si (KR)

(72) Inventors: Hoon Sik EOM, Ansan-si (KR); Hyun Seung JO, Ansan-si (KR); Byeong Cheol JU, Ansan-si (KR); Sang Hyun CHANG, Ansan-si (KR); Mi So KOH, Ansan-si (KR); Eun Mi CHOI, Ansan-si (KR)

(21) Appl. No.: 16/240,486

(22) Filed: Jan. 4, 2019

Related U.S. Application Data
(63) Continuation of application No. PCT/KR2017/007037, filed on Jul. 3, 2017.

(30) Foreign Application Priority Data
Jul. 4, 2016 (KR) 10-2016-0084446
Mar. 30, 2017 (KR) 10-2017-0040640
Apr. 21, 2017 (KR) 10-2017-0051792
Jun. 23, 2017 (KR) 10-2017-0079858

(51) Int. Cl. A01M 1/08; A01M 1/10; A01M 1/04; A01M 1/06

(52) U.S. Cl. CPC A01M 1/08; A01M 1/10; A01M 2200/012; A01M 1/06; A01M 1/04

(57) ABSTRACT

An insect trap including a main body having a suction fan, a first light emitting module mount disposed above the main body, a first light emitting module disposed on the first light emitting module mount, a roof disposed on the first light emitting module mount, an insect collection unit disposed under the main body, and an air collection unit disposed in the insect collection unit, the air collection unit having a substantially tapered shape to have a gradually decreasing diameter with an increasing distance from the suction fan, in which the first light emitting module mount includes a first light emitting module cover facing at least a portion of the first light emitting module, and the roof includes a pressing portion protruding from the roof and contacting at least one of the first light emitting module and the first light emitting module cover.

### CROSS REFERENCE TO RELATED APPLICATIONS

This application is a Bypass Continuation of International Patent Application No. PCT/KR2017/007037, filed on Jul. 3, 2017, and claims priority from and the benefit of Korean Patent Application No. 10-2016-0084446, filed on Jul. 4, 2016, Korean Patent Application No. 10-2017-0040640, filed on Mar. 30, 2017, Korean Patent Application No. 10-2017-0051792, filed on Apr. 21, 2017, and Korean Patent Application No. 10-2017-0079858, filed on Jun. 23, 2017, all of which are hereby incorporated by reference for all purposes as if fully set forth herein.

### BACKGROUND

### Field

Exemplary embodiments of the invention relate generally to an insect trap, and more specifically, to an insect trap including a light source and a suction fan.

### Discussion of the Background

Recently, the population of insect pests has been increasing due to climatic and social influences, such as global warming and eco-friendly policies. In addition to damaging crops and livestock, insect pests can also affect humans by transmitting pathogens, such as malaria, dengue fever, and Japanese encephalitis. For example, as a fear of being infected with zika virus (ZIKV) has spread in recent years, research on mosquito control methods is being actively conducted.

Some of the conventional pest control methods proposed include: chemical control using pesticides; biological control using loaches or the like; physical control that attracts insect pests using a blacklight trap, carbon dioxide or the like, followed by application of high voltage to kill the insect pests; and environmental control that improves the surrounding environment by eliminating water puddles where insect larvae can grow. However, chemical control has a problem of secondary pollution, and biological control or environmental control has a problem of high cost and much time and effort. In addition, physical control using an insect trap or the like has problems, such as complicated device configuration, causing deterioration in user friendliness, and increased risk from using a high-voltage device.

UV light sources have been used for medical purposes, such as sterilization, disinfection and the like; analytical purposes, such as analysis based on changes in radiated UV light; industrial purposes such as UV curing; cosmetic purposes such as UV tanning; and other purposes such as insect trapping, counterfeit money detection, and the like. Typical UV lamp used as such UV light sources include mercury lamps, excimer lamps, or deuterium lamps. However, such typical UV lamps may have high power consumption and heat generation, short lifespan, and environmental pollution due to toxic gases used in the lamps.

Recently, UV LEDs have been introduced as alternatives to the typical UV lamps described above. UV LEDs are advantageous in that the UV LEDs have low power consumption and cause less environmental pollution than the typical UV lamps. Accordingly, there have been studies of insect traps capable of attracting insects with luring light and trapping the insects a suction fan.

However, typical insect traps that attract insects using an UV LED and trap the attracted insects using a suction fan have a problem in that dead bodies of insects, such as mosquitoes, are likely to stick to the suction fan, which may cause noise in the suction fan. In addition, mosquitoes may escape from the insect trap or are not easily sucked into the insect trap due to inadequate control over the speed of the suction fan. Furthermore, hydrodynamic control over an air flow generated by the suction fan is not easy, which may deteriorate suction efficiency or increase power consumption.

In addition, such insect traps may generate odors therearound due to decomposition of dead bodies of insects, such as mosquitoes.

The above information disclosed in this Background section is only for understanding of the background of the inventive concepts, and, therefore, it may contain information that does not constitute prior art.

### SUMMARY

Insect traps constructed according to exemplary embodiments of the invention are eco-friendly and can be manufactured by simple processes while providing good insect attraction and suction.

An insect trap according to an exemplary embodiment may provide an optimal wind speed for mosquito suction while minimizing noise.

An insect trap according to an exemplary embodiment may include a first light emitting module to emit light having a wavelength and intensity, which are harmless to the human body and highly effective in attracting mosquitoes. An insect trap may also include a photocatalyst filter for providing deodorization.

An insect trap according to an exemplary embodiment may use both light and gas, such as carbon dioxide, to attract mosquitoes.

Additional features of the inventive concepts will be set forth in the description which follows, and in part will be apparent from the description, or may be learned by practice of the inventive concepts.

An insect trap according to an exemplary embodiment includes a main body including a suction fan, a first light emitting module mount disposed above the main body, a first light emitting module disposed on the first light emitting module mount, a roof disposed on the first light emitting module mount, an insect collection unit disposed under the main body, and an air collection unit disposed in the insect collection unit, the air collection unit having a substantially tapered shape to have a gradually decreasing diameter with an increasing distance from the suction fan, in which the first light emitting module mount includes a first light emitting module cover facing at least a portion of the first light emitting module, and the roof includes a pressing portion protruding from the roof and contacting at least one of the first light emitting module and the first light emitting module cover.

The air collection unit may include at least two sections having different slopes along a vertical direction.

The air collection unit may include a plurality of air collection unit ribs, and a plurality of air collection unit side openings formed between the air collection unit ribs through which air introduced into the insect trap by the suction fan pass therethrough.

Each of the air collection unit ribs may include two rod-shaped portions each having a predetermined length and width, and partially overlapping each other in a width direction, and an upper rod-shaped portion of one air collection unit rib may be disposed adjacent to a lower rod-shaped portion of an adjacent air collection unit rib.

The first light emitting module cover may include a front surface, a cover rim formed on at least one side of the front surface and having a greater thickness than the front surface, and a protrusion protruding from the cover rim.

The protrusion may include a cover protrusion protruding from the cover rim and extending in a longitudinal direction of the first light emitting module cover, and a cover step protruding from the cover rim and extending in a height direction of the first light emitting module cover, the cover protrusion and the cover step may be disposed on opposite surfaces of the first light emitting module cover, respectively.

The first light emitting module mount may include a first light emitting module insertion groove, a cover insertion groove, a cover step guide extending from the cover insertion groove toward the first light emitting module insertion groove, and a cover protrusion guide extending from the cover insertion groove away from the first light emitting module insertion groove.

The cover step guide and the cover protrusion guide may form a step with the cover insertion groove disposed therebetween.

The pressing portion may further include a pressing portion protrusion protruding toward the first light emitting module cover, the pressing portion protrusion contacting the first light emitting module cover to press the first light emitting module cover in a direction from a surface of the first light emitting module cover on which the cover step is formed to a surface of the first light emitting module cover on which the cover protrusion is formed.

The first light emitting module cover may have an open surface for receiving the first light emitting module, at least one surface of the first light emitting module cover being transparent, and the first light emitting module mount may have an opening to which at least a portion of the first light emitting module cover is configured to be inserted, such that a seated portion of the first light emitting module cover is seated on an upper surface of the first light emitting module mount, and the roof is mounted on the first light emitting module mount and the first light emitting module cover.

An insect trap according to another exemplary embodiment includes a main body including a suction fan, a first light emitting module mount disposed above the main body, a first light emitting module disposed on the first light emitting module mount, a second light emitting module mount disposed under the suction fan, a second light emitting module disposed on the second light emitting module mount, a photocatalyst filter disposed under the second light emitting module mount, a roof disposed on the first light emitting module mount, and an insect collection unit disposed under the main body, in which the first light emitting module mount includes a first light emitting module cover facing at least a portion of the first light emitting module, the roof includes a pressing portion contacting at least one of the first light emitting module and the first light emitting module cover, and the second light emitting module is configured to emit light toward the photocatalyst filter.

The insect trap may further include an air collection unit disposed under the main body and having a substantially tapered shape to have a gradually decreasing diameter with an increasing distance from the suction fan, and a photocatalyst filter mount disposed under the second light emitting module mount and extending from the air collection unit.

The insect trap may further include a second protrusion extending from a lower side of the second light emitting module mount and surrounding at least a portion of the second light emitting module mount.

The air collection unit may include an air collection unit inlet, an air collection unit midsection, and an air collection unit outlet extending toward the insect collection unit, and magnitudes of slope in a vertical direction may decrease from the air collection unit outlet, the air collection unit inlet, and the air collection unit midsection.

An insect trap according to yet another exemplary embodiment includes a main body including a suction fan, a first light emitting module mount disposed above the main body, a first light emitting module disposed on the first light emitting module mount, a roof disposed on the first light emitting module mount, an insect collection unit disposed under the main body, and a sensor unit including at least one of an illuminance sensor configured to detect illuminance of ambient light, a motion sensor configured to detect information on user's approach to the insect trap, and a UV sensor configured to detect information on luminous intensity of the first light emitting module, in which the first light emitting module mount includes a first light emitting module cover facing at least a portion of the first light emitting module, and the roof includes a pressing portion contacting at least one of the first light emitting module and the first light emitting module cover.

The information on user's approach to the insect trap may include user's proximity to the insect trap, and the first light emitting module may be configured to reduce luminous intensity when the user's proximity to the insect trap is less than a predetermined value.

The first light emitting module mount may have a substantially plate-shape to mount the first light emitting module disposed at a lower surface thereof, and the UV sensor may be disposed on the lower surface of the first light emitting module mount, and may be configured to be directly irradiated with light emitted from the first light emitting module and be shielded from light from the outside of the insect trap by the first light emitting module mount.

The first light emitting module mount may have a substantially plate-shape to mount the first light emitting module to be disposed at a lower surface thereof, and the UV sensor may be disposed on the first light emitting module, and be configured to be directly irradiated with light emitted from the first light emitting module and be shielded from light from the outside of the insect trap by the first light emitting module mount.

The first light emitting module may be configured to have light output less than or equal to about 100 mW, when illuminance of ambient light detected by the illuminance sensor is less than or equal to 20 lux.

The first light emitting module may be configured to have light output less than or equal to about 100 mW.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a perspective view of an insect trap according to an exemplary embodiment.

FIG. 2 is a side view of an insect trap according to an exemplary embodiment.

FIG. 3 is a cross-sectional view of an insect trap according to an exemplary embodiment.

FIG. 4 is an exploded perspective view of an insect trap according to an exemplary embodiment.

FIG. 5, FIG. 6, and FIG. 7 are views of an air collection unit according to exemplary embodiments.

FIG. 8, FIG. 9, and FIG. 10 are views of a first light emitting module according to exemplary embodiments.

FIG. 11 is a bottom view of an insect passage unit according to an exemplary embodiment.

FIG. 12 and FIG. 13 are views of a first light emitting module cover according to exemplary embodiments.

FIG. 14 is a view of a first light emitting module cover and a first light emitting module mounted on a first light emitting module mount according to an exemplary embodiment.

FIG. 15 is a view of a first light emitting module cover according to an exemplary embodiment.

FIG. 16 is a bottom view of a roof according to an exemplary embodiment.

FIG. 17 and FIG. 18 are views of a second protrusion disposed under a main body according to an exemplary embodiment.

FIG. 19 is a block diagram of an insect trap according to an exemplary embodiment.

FIG. 20 is a block diagram of a sensor unit according to an exemplary embodiment.

FIG. 21 is a block diagram of a light source control by an illuminance sensor according to an exemplary embodiment.

FIG. 22, FIG. 23, and FIG. 24 are graphs of a waveform of driving voltage depending on PWM control for a light source according to exemplary embodiments.

FIG. 25 is a schematic circuit diagram of a light source according to an exemplary embodiment.

FIG. 26, FIG. 27, and FIG. 28 are views of insect traps according to an exemplary embodiment.

FIG. 29A and FIG. 29B are views schematically illustrating the light emission angle and light radiation range of first light emitting diode chips according to exemplary embodiments.

FIG. 30A is a graph showing a light emission angle of FIG. 29A, and FIG. 30B is a light emission angle of FIG. 29B.

FIG. 31A, FIG. 31B, FIG. 31C, FIG. 31D, and FIG. 31E are views of a first light emitting module substrate according to exemplary embodiments.

FIG. 32 is a view of a first light emitting module and a first light emitting module cover of the insect trap according to an exemplary embodiment.

FIG. 33 is an exploded perspective view of an insect trap according to an exemplary embodiment.

FIG. 34 is a side view of the insect trap according to an exemplary embodiment.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z—axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As is customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Hereinafter, embodiments of the present invention will be described with reference to the accompanying drawings. As used herein, the term “insects” may refer to insect pests, for example, mosquitoes.

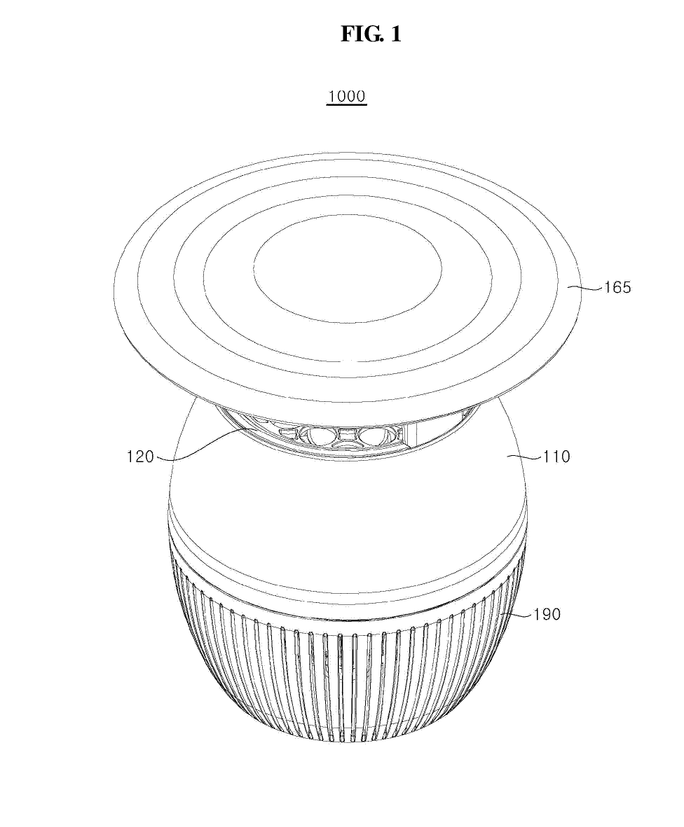

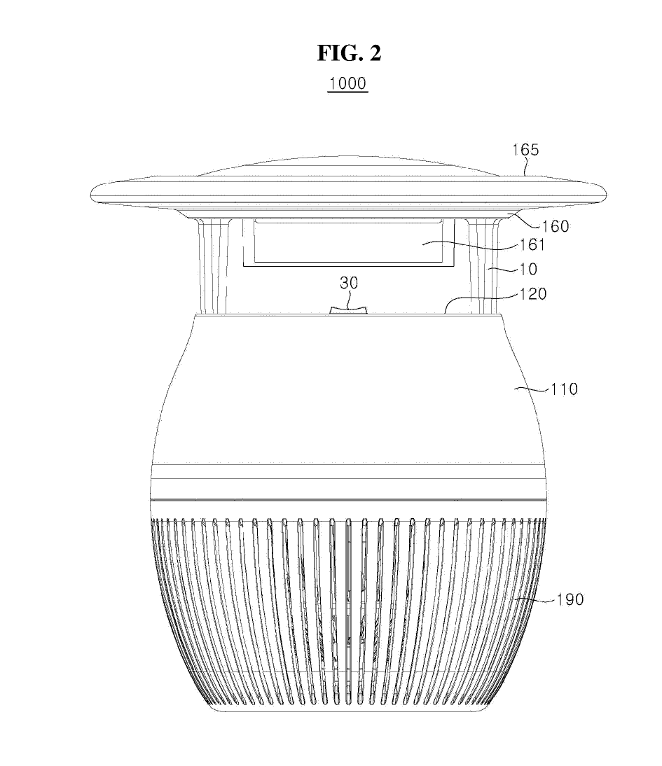

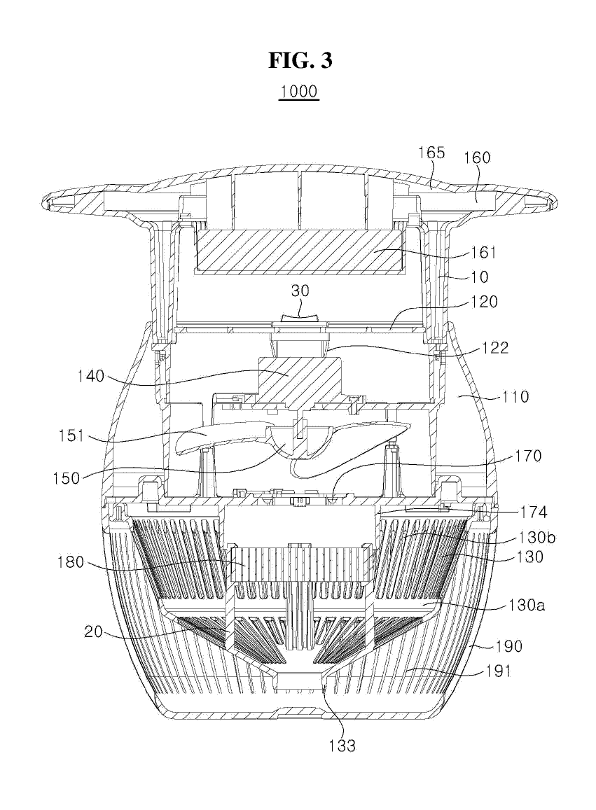

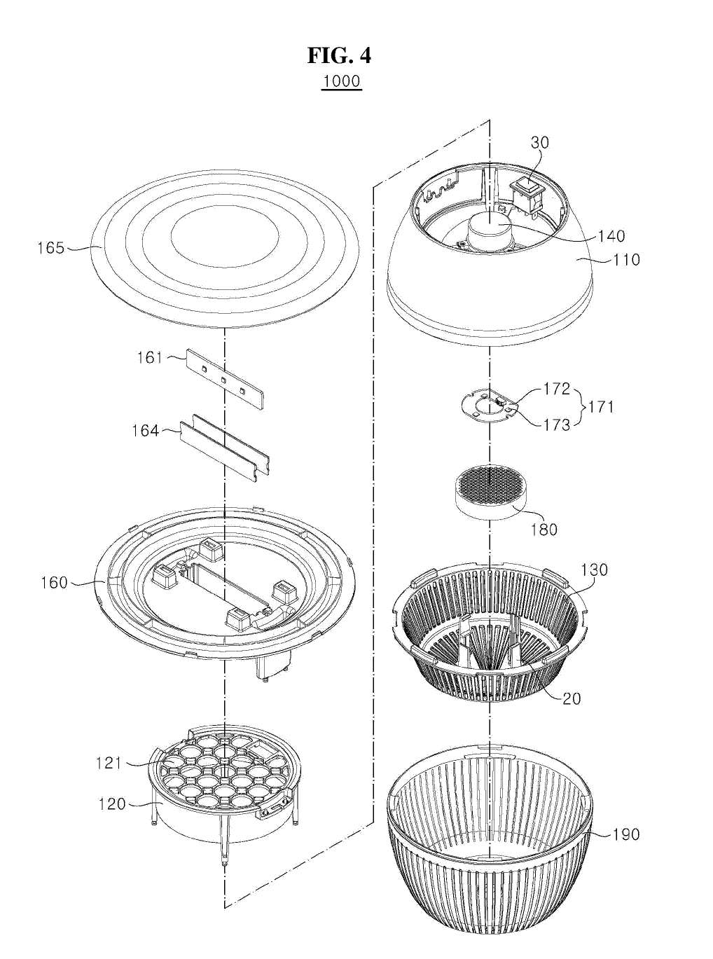

FIG. 1 is a perspective view of an insect trap according to an exemplary embodiment. FIG. 2 is a side view of the insect trap according to an exemplary embodiment, FIG. 3 is a cross-sectional view of the insect trap according to an exemplary embodiment, and FIG. 4 is an exploded perspective view of the insect trap according to an exemplary embodiment.

Referring to FIGS. 1 to 4, an insect trap 1000 according to an exemplary embodiment includes: a main body 110; an insect passage unit 120 disposed on the main body 110 and through which insects may pass; an air collection unit 130 disposed under the main body 110; a suction fan 150 disposed between the air collection unit 130 and the insect passage unit 120; a first light emitting module mount 160 disposed above the insect passage unit 120 and to which a first light emitting module 161 may be mounted; an insect collection unit 190 disposed under the air collection unit 130 to collect insects; a second light emitting module mount 170 disposed between the suction fan 150 and the insect collection unit 190 and to which a second light emitting module 171 may be mounted; and a photocatalyst filter mount 20 disposed under the second light emitting module mount 170 and to which a photocatalyst filter 180 may be mounted. The air collection unit 130 may include at least two tapered sections to have a gradually decreasing diameter with an increasing distance from the suction fan 150, and having different slopes in vertical section.

As used herein, the term “light emitting module” may include various light sources, such as UV LEDs.

Main Body 110

The main body 110 may have a substantially cylindrical shape to mount the suction fan 150 therein. However, the inventive concepts are not limited to a particular shape of the main body 110. For example, the main body 110 may have a convex pot-like shape to secure an internal space, to create a smooth suction flow, and to secure a space through which an electric wire for supplying electric power to a motor 140 or to the second light emitting module 171 may pass. The main body 110 may be formed of any commercially available plastic material suitable for long-term indoors or outdoors use and reduction in manufacturing costs, without limitation. In addition, the main body 110 may be opened at the top and bottom thereof to allow air to vertically pass therethrough.

Referring to FIG. 3, a switch 30, the insect passage unit 120, the motor 140, the suction fan 150, and the second light emitting module mount 170 may be sequentially mounted in the main body 110 from the top of the main body 110.

Referring to FIG. 4, the insect passage unit 120 may include a plurality of insect passage holes 121 for selective passage of insects. Although the shape of the plurality of insect passage holes 121 is not particularly restricted, the insect passage holes 121 may have a substantially circular member and a substantially radial member, for example, a series of substantially circular members, and may have a size in consideration of average size of target insects. When the insect passage holes 121 of the insect passage unit 120 have a series of substantially circular members, as shown in FIG. 4, the size of the insect passage holes 121 can be effectively controlled at low manufacturing costs.

In conventional insect traps using a suction fan, insects larger in volume than mosquitoes, such as butterflies, dragonflies, and flies can also be collected, which may shorten replacement cycle for an insect collection unit 190 or may cause damage to the ecosystem due to collection of beneficial insects. In addition, insects having a large volume are likely to stick to the suction fan 150, which may shortened lifespan of the motor 140 or generate noise from the suction fan 150. The insect trap 1000 according to an exemplary embodiment includes the insect passage unit 120 to selectively suck in insects by controlling the size of the insect passage holes 121.

Each of the insect passage holes 121 may have a diameter of about 0.5 cm to about 2 cm, specifically to about 0.8 cm to about 1.5 cm, and an area of about 100 mm² to about 225 mm². Accordingly, the insect passage holes 121 can prevent insects relatively large in body size, such as butterflies, dragonflies, and flies, from entering the insect trap 1000 while allowing passage of specific insects, particularly mosquitoes, thereby preventing deterioration in durability of the motor 140 and reducing noise generated by the suction fan 150.

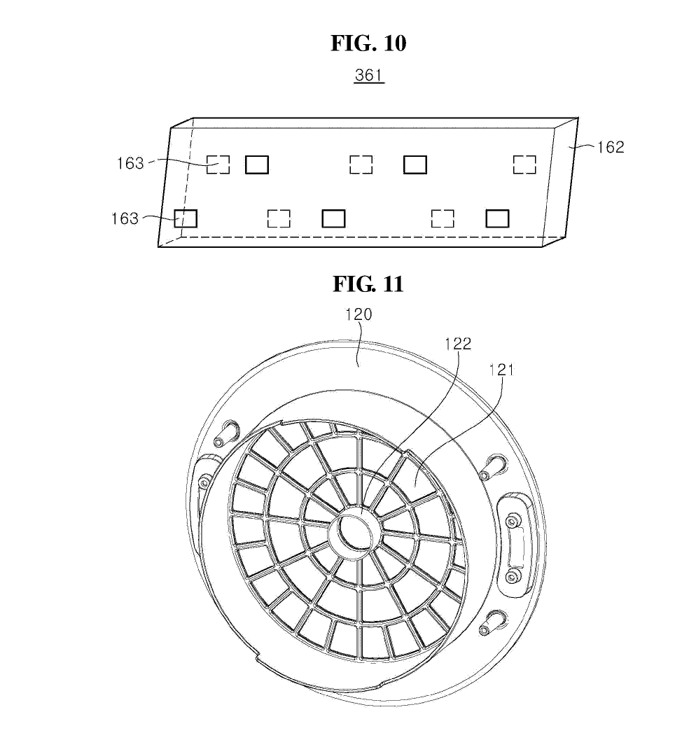

For example, referring to FIG. 11, the insect passage unit 120 may have a first protrusion 122 extending from a lower surface thereof and disposed above the motor 140. The first protrusion 122 may prevent separation of the motor 140, the suction fan 150, and the like in the event of impact to the insect trap 1000. The first protrusion 122 may be separated from the motor 140 by about 0.5 mm to about 5 mm, for example, to reduce the space for vibration of the motor 140 or the suction fan 150 when the insect trap 1000 is impacted.

The suction fan 150 according to an exemplary embodiment may allow insects to pass therethrough without sticking thereto. In conventional insect traps using a suction fan 150, insects are likely to stick to a fan blade 151, such that the rotation radius of the suction fan 150 may become not uniform, causing deterioration in durability of a motor 140 or noise generation. However, reducing the rotation speed of the suction fan 150 to prevent insects from sticking to the fan blade 151 causes poor efficiency in collecting insects near the insect trap. In general, insects tend to stop flying at a wind speed of about 0.8 m/s or more, and attempt to escape from a stream of air at an excessively high wind speed. The insect trap 1000 according to an exemplary embodiment may cause mosquitoes to stop flying and be trapped therein by a suction air flow generated by the suction fan 150 while preventing insects from sticking to a fan blade 151.

More particularly, the suction fan 150 may include 2 to 7, more specifically, 3 or 4 fan blades 151 and may rotate at about 1,800 rpm to about 3,100 rpm, more specifically at about 2,000 rpm to about 2,800 rpm. If the number of fan blades 151 is less than 2 or the suction fan 150 has an rpm of less than about 1,800, mosquito trapping efficiency may de deteriorated. When the number of fan blades 151 exceeds 7 or the suction fan 150 has an rpm of more than about 3,100, too many bodies of dead pests are likely to stick to the suction fan 150, or noise may exceed about 38 dBA.

The fan blade 151 according to an exemplary embodiment may be curved with a constant or non-constant curvature. For example, a height difference between the lowermost portion and the uppermost portion of the curved fan blade 151 may range from about 5 mm to about 50 mm. The suction fan 150 may have a diameter of about 50 mm to about 120 mm, more specifically, from about 70 mm to about 100 mm. Further, a shortest distance between the suction fan 150 and an inner wall of the main body 110 may be adjusted in the range of about 1 mm to about 5 mm, thereby effectively creating a suction air flow while minimizing noise generated by the suction fan 150.

A ratio of the vertical distance from the main body 110 to the first light emitting module mount 160 to the height of the main body 110 may range from about 1:1 to about 1:4, and a ratio of the height of the insect collection unit 190 to the distance from the insect collection unit 190 to the first light emitting module mount 160 may range from about 1:0.8 to about 1:2. In this manner, an air flow can be effectively created by the suction fan 150, and insects near the insect trap 1000 can be easily suctioned into the insect trap without sticking to the suction fan 150.

Accordingly, the speed of an air flow created between the insect passage unit 120 and the first light emitting module mount 160 by the suction fan 150 may be in the range of from about 0.5 m/s to about 3.0 m/s, more specifically about 0.6 m/s to about 2.8 m/s, more specifically about 0.7 m/s to about 2.5 m/s, for example, about 0.7 m/s to about 2.3 m/s. In this manner, the insect trap 1000 can force insects to stop flying and be captured in the insect collection unit 190 with high efficiency without the insects sticking to the suction fan 150 and suppressing noise generation from the suction fan 150. As used herein, the speed of the air flow may be measured using an anemometer (TSI 9515, manufactured by TSI Inc.) at the midpoint between an upper end of the main body 110 of the insect trap 1000 and the first light emitting module mount 160.

The insect trap 1000 according to an exemplary embodiment may have a ratio of the vertical distance from an entrance of the insect passage unit 120 to the lower surface of the first light emitting module mount 160 to the height of the main body 110 in the range of about 1:1 to about 1:4, a ratio of the height of the insect collection unit 190 to the distance from the insect collection unit 190 to the first light emitting module mount 160 in the range of about 1:0.8 to about 1:2, and the rotation speed of the suction fan 150 in the range of about 1,800 rpm to about 3,100 rpm, such that an air flow created between the insect passage unit 120 and the first light emitting module mount 160 may be in the range of about 0.5 m/s to about 3.0 m/s to collect the insects in the insect collection unit 190 without insects sticking to the suction fan 150.

Since the motor 140 is mounted on a lower side of the insect passage unit 120, and the suction fan 150 is mounted on a lower side of the motor 140, noise generated by the motor 140 and the suction fan 150 can be significantly reduced to less than 38 about dB, for example. As used herein, the noise may be measured at a moderate sound level of 29.8 dBA using a sound level tester (CENTER 320, TESTO Co., Ltd.) at a horizontal distance of 1.5 m from the insect trap 1000.

Air Collection Unit 130, 230, 330

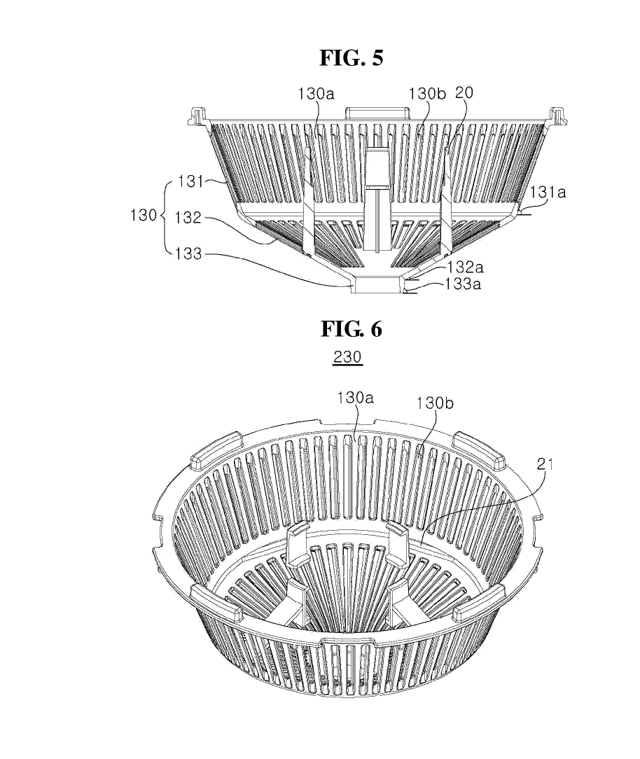

FIG. 5, FIG. 6, and FIG. 7 are views of air collection units 130, 230, 330 according to exemplary embodiments.

Referring to FIG. 3 to FIG. 7, the air collection unit 130, 230, or 330 may be mounted on the lower side of the main body 110, such that insects introduced into the main body 110 by the suction fan 150 may be discharged thereto. The air collection unit 130, 230, and 330 may include an air collection unit rib 130a, an air collection unit side opening 130b, and an air collection unit outlet 133. The air collection unit 130, 230, or 330 may have a substantially conical shape or tapered shape to have a gradually decreasing diameter with an increasing distance from the suction fan 150. The air collection unit 130, 230, or 330 may further include sections having different slopes in vertical section.

The air collection unit 130, 230, or 330 may be tapered to have a gradually decreasing diameter with an increasing distance from the suction fan 150, and includes two or more, for example, three sections having different slopes in vertical section in order to effectively send an air flow generated by the suction fan 150 to the underlying insect collection unit 190 without dispersion of the air flow.

More particularly, the air collection unit 130, 230, or 330 may sequentially include a steep section, a gentle section, and a vertical section (e.g., the air collection unit outlet 133) along a vertical direction from the top to bottom thereof. For example, the air collection unit outlet 133 may have a greater magnitude of slope in the vertical direction that that of the air collection unit inlet 131, and the air collection unit inlet 131 may have a greater magnitude of slope in the vertical direction than that of the air collection unit midsection 132.

In this manner, mosquitoes captured in the insect collection unit 190 may be collected into a space formed between the air collection unit inlet 131 and the insect collection unit 190, thereby suppressing the captured mosquitoes from escaping the insect trap 1000 even when the suction fan 150 does not rotate.

For example, the air collection unit inlet 131 may have an angle of about 45° to about 60°, more specifically, about 60° to about 85°, with respect to the ground in the vertical direction. When the angle between the air collection unit inlet 131 and the ground is less than about 45°, the frequency of the captured mosquitoes from escaping the insect trap 1000 may be excessively increased upon stopping the suction fan 150. In addition, when the angle between the air collection unit inlet 131 and the ground exceeds about 80°, a space formed between the air collection unit 130, 230, or 330 and an inner wall of the insect collection unit 190 may become too narrow to collect the mosquitoes in a space formed between the air collection unit inlet 131 and the insect collection unit 190.

When the air collection unit 130, 230, or 330 includes the air collection unit outlet 133 protruding toward the insect collection unit 190, e.g., in the downward direction, mosquitoes may stick to the air collection unit outlet 133, and the frequency of the captured mosquitoes escaping from the insect trap 1000 may be significantly reduced when the suction fan 150 stops rotating. For example, the air collection unit outlet 133 may have a vertical length of about 0.2 cm to about 2 cm, more specifically, about 0.5 cm to about 1.5 cm. If the vertical length of the air collection unit outlet 133 exceeds about 2 cm, the air collection unit outlet 133 can interfere with a suction air flow created by the suction fan 150, whereas, if the vertical length of the air collection unit outlet 133 is less than about 0.2 cm, an area of the air collection unit outlet 133 to which mosquitoes may stick upon the stopping the suction fan 150 can be too small to effectively suppress escaping of the captured mosquitoes from the insect trap 1000.

Referring to FIG. 5, the air collection unit 130 according to an exemplary embodiment may include a plurality of air collection unit ribs 130a and a plurality of side openings 130b between the air collection unit ribs 130a to allow air introduced by the suction fan 150 to pass therethrough.

With the side openings 130b formed in the air collection unit 130, 230, or 330, an air flow generated by the suction fan 150 can effectively exit the insect trap 1000. The side openings 130b may have the shape of a mesh or a slit, without being limited thereto. The mesh- or slit-shaped side openings may have that size that may not allow insects, particularly mosquitoes, to pass therethrough.

When the side opening 130b has a substantially slit shape, each of the air collection unit ribs 130a may include two rod-shaped portions, each having a predetermined length and width and partially overlapping each other in the width direction. An upper rod-shape portion of one air collection unit rib 130a may be disposed close to a lower rod-shape portion of an adjacent air collection unit rib 130a. More particularly, the air collection unit 130, 230, or 330 may include a series of structures having an upper rod-shaped portion of one air collection unit rib 130a that faces a lower rod-shaped portion of an adjacent air collection unit rib 130a with one air collection unit side opening 130b therebetween. In this manner, an air flow can be effectively created by the suction fan 150 while reducing the frequency of captured mosquitoes in the insect collection unit 190 from escaping the insect trap 1000 when the suction fan 150 stops rotating. When the air collection unit ribs 130a and the air collection unit side openings 130b extend substantially in a vertical direction of the insect trap 1000, air resistance can be much lower than when the air collection unit ribs 130a and the air collection unit side openings 130b extend substantially in a horizontal direction of the insect trap 1000. As such, it is possible to prevent an unsmooth air flow due to mosquitoes caught in the air collection unit side openings 130b.

In particular, the shape of the air collection unit rib 130a may be varied depending on the direction of an air flow created by the suction fan 150. More particularly, the air collection unit rib 130a may be shaped such that an air flow created by the suction fan 150 first contacts the upper rod-shaped portion of the air collection unit rib 130a and then contacts the lower rod-shaped portion of the air collection unit rib 130a, whereby the air flow created by the suction fan 150 can effectively escape through the air collection unit side opening 130b, thereby allowing hydrodynamic control over the suction air flow. In this manner, the speed of an air flow created by the suction fan 150 of the insect trap 1000 according to an exemplary embodiment may be in the range of about 0.5 m/s to about 3 m/s even when the suction fan 150 has an rpm of about 1,800 to about 3,100, such that the insects sucked into the insect trap 1000 can be collected in the insect collection unit 190 without sticking to the suction fan 150 in the event of physical impact to the insect trap 1000.

With the air collection unit 130, 230, or 330 having different slopes in vertical section, the shape of the air collection unit outlet 133, and the shape of the air collection unit rib 130a, the insect trap 1000 according to an exemplary embodiment allows a suction air flow created by the suction fan 150 to effectively exit the air collection unit 130, 230, or 330, thereby improving insect trapping efficiency while preventing insects captured in the insect collection unit 190 from escaping from the insect trap 1000 through the air collection unit 130, 230, or 330.

Insect Collection Unit 190

Referring back to FIG. 3 and FIG. 4, the insect collection unit 190 may include insect collection unit side openings 191 to discharge air introduced by the suction fan 150 to the outside.

A ratio of the sum of areas of the insect passage holes 121 and the sum of areas of the insect collection unit side openings 191 may range from about 1:0.8 to about 1:3.0, more specifically about 1:0.8 to about 1:2.0, such that a flow of air discharged outside the insect trap 1000 may not be restricted with the amount of insects captured, even when captured insects occupy half the volume of the insect collection unit 190, for example.

As such, the insect collection unit 190 according to an exemplary embodiment allows an air flow generated by the suction fan 150 to be effectively discharged outside the insect trap 1000, whereby mosquitoes captured in the insect collection unit 190 may be dried and eradicated.

First Light Emitting Module Mount 160

Referring back to FIG. 1 to FIG. 4, the insect trap 1000 according to an exemplary embodiment may further include a first light emitting module mount support 10 disposed between the suction fan 150 and the insect collection unit 190. The first light emitting module mount support 10 may support the first light emitting module mount 160, and provide a space for introducing insects between the first light emitting module mount 160 and the main body 110.

The inventive concepts are not limited to a particular number and shape of the first light emitting module mount support 10, however, in one exemplary embodiment, the first light emitting module mount support 10 may include two first light emitting module mount supports facing each other to stably support the first light emitting module mount 160 while minimizing a space occupied by the first light emitting module mount support 10 to secure a space sufficiently large to allow insects to be introduced into the insect trap 1000.

The length of the first light emitting module mount support 10 may be about 1 cm to about 8 cm, more specifically about 2 cm to about 5 cm, such that the first light emitting module mount 160 is vertically separated from the main body 110. More specifically, the height of the first light emitting module mount support 10 may be substantially equal to the vertical distance from the main body 110 to the first light emitting module mount 160. If the vertical distance from the main body 110 to the first light emitting module mount 160 is less than about 1 cm, a space into which insects are introduced is excessively small, causing reduction in insect trapping efficiency, whereas, if the vertical distance from the main body 110 to the first light emitting module mount 160 exceeds about 8 cm, an air flow created by the suction fan 150 may have in sufficient intensity, causing reduction in insect trapping efficiency.

In this manner, when an insect is attracted to luring light, such as UV light, and comes near the insect trap 1000, the insect can be introduced into a space between the main body 110 and the first light emitting module mount 160 by a suction air flow created by the suction fan 150, and captured in the insect collection unit 190 disposed under the air collection unit 130, 230, or 330 after passing through the insect passage unit 120 and the suction fan 150.

Referring to FIG. 1 or FIG. 4, the first light emitting module mount 160 may have a substantially plate shape. With the first light emitting module mount 160 having a substantially plate shape, the insect trap 1000 according to an exemplary embodiment can control an air flow created by the suction fan 150 to flow into a space between the first light emitting module mount 160 and the main body 110, such that a suction air flow can be generated in a hydro-dynamically efficient manner by the suction fan 150. As such, the speed of the suction air flow can be in the range of about 0.5 m/s to about 3 m/s even when the suction fan 150 has an rpm of about 1,800 to about 3,100, whereby mosquitoes can be captured in the insect collection unit 190 without sticking to the suction fan 150.

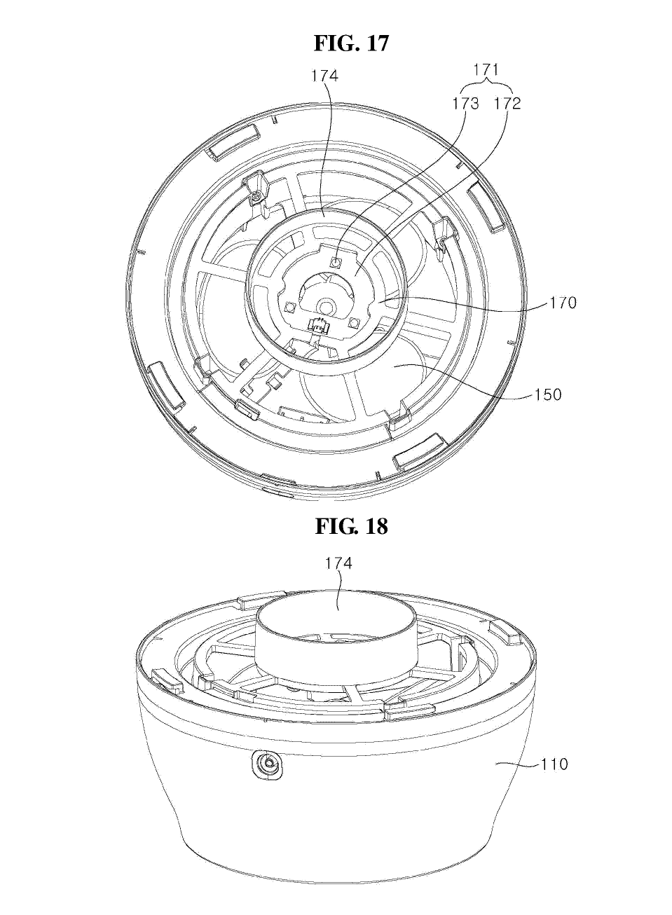

Referring to FIG. 4, the first light emitting module 161 may be mounted on a lower surface of the first light emitting module mount 160. For example, after removal of a detachable roof 165 from an upper end of the first light emitting module mount 160, the first light emitting module 161 may be mounted on the first light emitting module mount 160 by being inserted into the first light emitting module mount 160 from above. For example, referring to FIG. 16, the roof 165 may include a pressing portion 265 on a lower surface thereof to vertically or horizontally press at least one of the first light emitting module 161 and a first light emitting module cover 164 or 1164, thereby preventing noise due to vibration of the first light emitting module 161 and the first light emitting module cover 164 or 1164. For example, the pressing portion 265 may have a pressing portion protrusion 365 to more firmly vertically or horizontally press at least one of the first light emitting module 161 and the first light emitting module cover 164 or 1164. The protrusion 365 may press the first light emitting module cover 164 in a direction from a surface of the first light emitting module cover 164 on which a cover step 464 is formed to a surface of the first light emitting module cover 164 on which a cover protrusion 564 is formed. In this manner, noise due to vibration of the first light emitting module cover 164 or 1164 may be reduced and deterioration of pest attraction efficiency due to vibration of the first light emitting module cover 164 or 1164 may be prevented, while allowing an opening of the first light emitting module mount 160 to be more firmly pressed by the cover protrusion 564, thereby preventing the first light emitting module 161 from being damaged by intrusion of pollutants or insects. The first light emitting module 161 mounted on the first light emitting module mount 160 may be electrically connected to a power supply terminal.

In an exemplary embodiment, the first light emitting module 161 may be mounted on the first light emitting module mount 160 to emit light in substantially horizontal direction with respect to the ground. Insects, especially mosquitoes, stay longest at a height of about 1.5 m from the ground during flight. When the insect trap 1000 is installed at a height of about 1.5 m from the ground, insects can be strongly influenced by light emitted from a UV LED module 161 in a horizontal direction with respect to the ground and be effectively attracted to the insect trap 1000.

In some exemplary embodiments, the insect trap 1000 may further include a roof hanger formed on an upper surface of the roof 165 to be hanged on a branch at a height of about 1.5 m from the ground for outdoor use.

In an exemplary embodiment, a material capable of reflecting UV light emitted from the first light emitting module 161, such as silver or aluminum, may be attached to or coated on a lower surface of the first light emitting module mount 160. For example, the lower surface of the first light emitting module mount 160 may be coated with a silver or aluminum film and may further have various types of curved or uneven patterns to scatter incident light.

Referring to FIG. 4, the first light emitting module mount 160 may include a first light emitting module cover 164 mounted thereon to face the first light emitting module 161 to protect the first light emitting module 161 from dust or insects. In an exemplary embodiment, the first light emitting module cover 164 may be transparent.

The first light emitting module cover 164 may be formed in various shapes to function as a lens for diffusing light from the first light emitting module 161 or for converging light in a predetermined direction. The first light emitting module cover 164 may be formed of, for example, glass or quartz. Alternatively, the first light emitting module cover 164 may be formed of poly(methyl methacrylate) (PMMA) having a monomer content of about 80% or more, which is mainly composed of carbon and hydrogen, and thus, has a thin electron cloud and high UV transmittance. In some exemplary embodiments, the first light emitting module cover 164 may be formed of a fluorine-based polymer that is stable to UV light for being nonreactive. When the first light emitting module cover 164 is formed of a fluorine-based polymer, the first light emitting module cover 164 may be formed to be flexible and thin, such that the fluorine-based polymer may have a lower UV transmittance than quartz or PMMA. More particularly, in order to increase UV transmittance of the first light emitting module cover 164 formed of the fluorine-based polymer, since the fluorine-based polymer has a lower UV transmittance than quartz or PMMA, the first light emitting module cover 164 may be formed thin. However, since reducing the thickness of the first light emitting module cover 164 may cause the first light emitting module cover 164 to be easily broken by slight impact due to brittleness of the polymer, the first light emitting module cover 164 according to an exemplary embodiment may be formed of a soft and flexible material to have reduced brittleness.

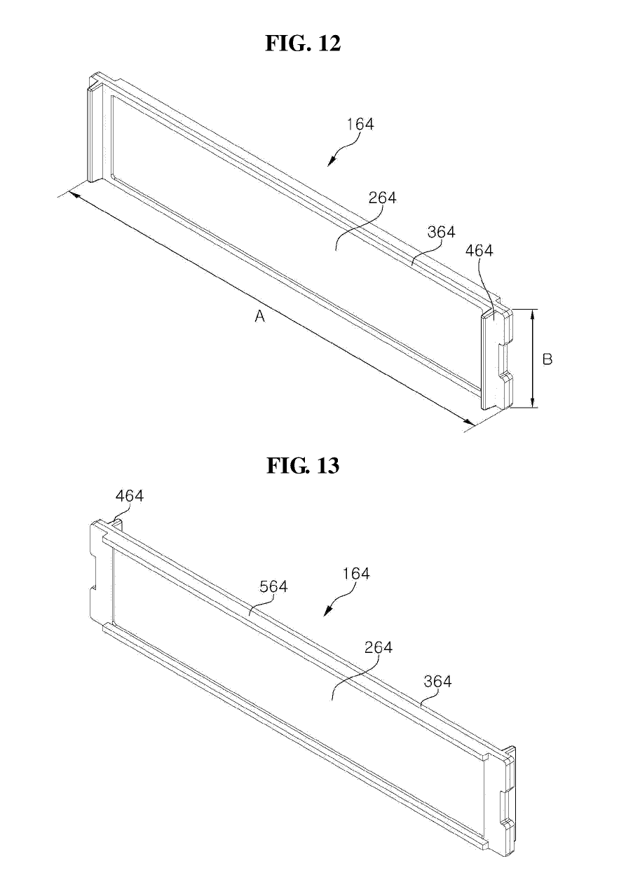

For example, referring to FIG. 12 and FIG. 13, the first light emitting module cover 164 may be disposed in the first light emitting module mount 160 to face at least a portion of the first light emitting module 161. In addition, the first light emitting module cover 164 may have a front surface 264 and a cover rim 364 formed on at least one side of the front surface 264. The front surface 264 may have a smaller thickness than the cover rim 364. In particular, the front surface 264, through which light from the first light emitting module 161 passes, may be formed relatively thin to increase transmittance of light emitted from the first light emitting module cover 164, and the cover rim 364 may be formed relatively thick to improve durability of the first light emitting module cover 164.

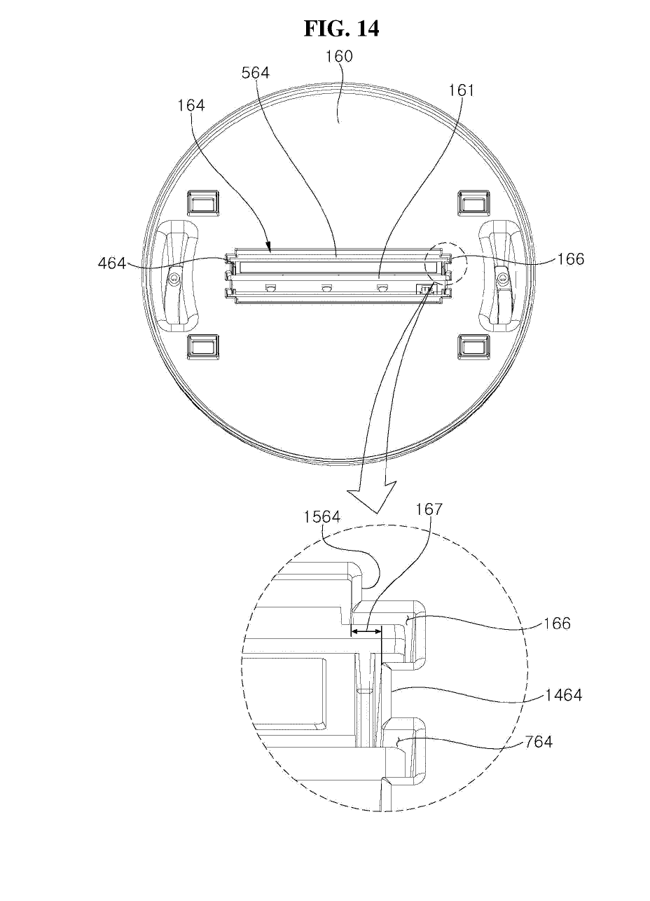

In addition, referring to FIG. 12 and FIG. 13, the first light emitting module cover 164 includes a cover protrusion 564 protruding from the cover rim 364 and extending substantially in a longitudinal direction of the first light emitting module cover 164, and a cover step 464 protruding from the cover rim 364 and extending substantially in a height direction of the first light emitting module cover 164. The cover protrusion 564 and the cover step 464 may be formed on opposite surfaces of the first light emitting module cover 164, respectively 164. For example, referring to FIG. 13, the first light emitting module cover 164 may include at least one cover protrusion 564 protruding perpendicular from the front surface 264. In addition, referring to FIG. 14, the first light emitting module mount 160 may include a cover step guide 1464 extending from a cover insertion groove 166 toward a first light emitting module insertion groove 764, and a cover protrusion guide 1564 extending from the cover insertion groove 166 away from the first light emitting module insertion groove 764. The cover step guide 1464 and the cover protrusion guide 1564 may be stepped 167 with respect to each other with the cover insertion groove 166 therebetween. More specifically, referring to FIG. 14, the first light emitting module cover 164 may be inserted into the cover insertion groove 166 and tightly secured to the first light emitting module mount 160 by the cover step 464 of the first light emitting module cover 164, thereby preventing noise due to vibration of the first light emitting module cover 164 while preventing deterioration of insect attraction efficiency due to vibration of the first light emitting module cover 164 or 1164. In addition, with the cover protrusion 564 of the first light emitting module cover 165, the insect trap can further prevent the first light emitting module 161 from being damaged by intrusion of dust or insects.

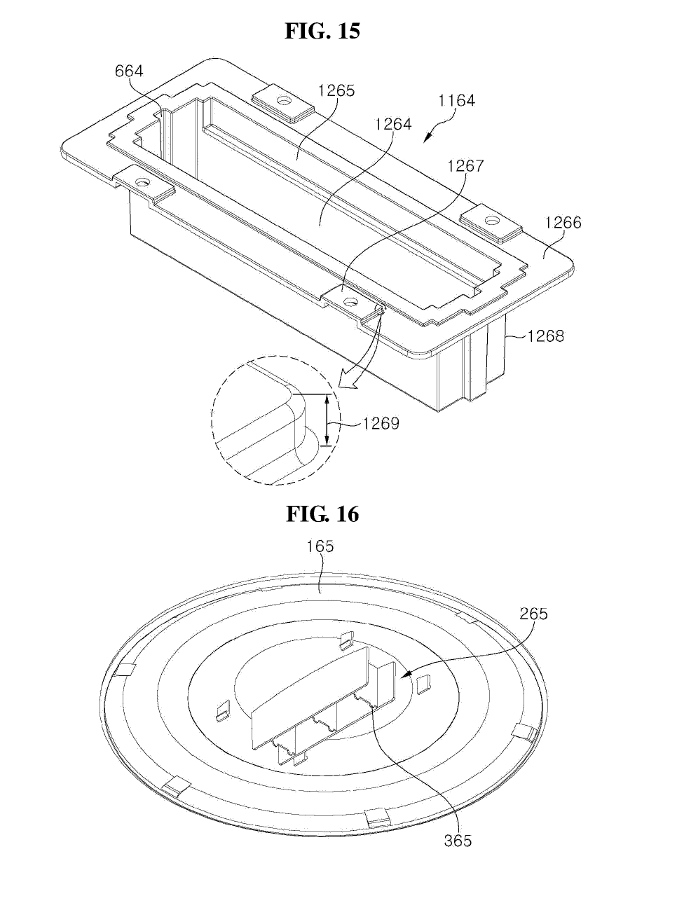

The first light emitting module cover 1164 according to an exemplary embodiment may be waterproof. Referring to FIG. 15, the first light emitting module cover 1164 may be provided with an open space including a first light emitting module insertion groove 664 into which the first light emitting module 161 is inserted, and may have a front surface 1264 facing the first light emitting module 161. In addition, the first light emitting module cover 1164 may be entirely or at least partially transparent. For example, at least a portion of the front surface 1264 may include a transparent region. For example, the first light emitting module cover 1164 may include a housing 1268 receiving the first light emitting module 161 and a seated portion 1266 formed on at least one side of the housing 1268.

For example, the front surface 1264 may include a protrusion plate 1265 protruding outside the first light emitting module cover 1164, e.g., outside the housing 1268. Insect pests, especially mosquitoes, tend to be more strongly attracted to refracted or diffused light than direct light. With the protrusion plate 1265 formed at a portion of the front surface 1264, through which light from the first light emitting module 161 passes, the insect trap can refract or diffuse light from the first light emitting module 161, thereby improving pest attraction efficiency. For example, the protrusion plate 1265 may be provided in the form of a step protruding from the other surface of the housing 1268, and may have a plate-like shape having a predetermined length, height, and thickness. For example, the protrusion plate 1265 may include a single or plural steps, and the step may protrude vertically or in an inclined manner from the other surface of the housing 1268, and may be at least partially uneven to effectively refract or diffuse light, thereby improving pest attraction efficiency and pest trapping efficiency.

For example, the first light emitting module cover 1164 may include a seated portion 1266 formed on at least one side of the housing 1268, such that the first light emitting module cover 1164 can be seated on the first light emitting module mount 160. When at least a portion of the first light emitting module cover 1164 is inserted into an opening of the first light emitting module mount 160, insertion of the housing 1268 is stopped by the seated portion 1266 extending substantially in a plate shape from an end of the housing. The insect trap according to an exemplary embodiment may further include a roof 165 mounted on the first light emitting module mount 160. After the first light emitting module cover 1164 is inserted into the opening of the first light emitting module mount 160, and the seated portion 1266 is seated on and secured to the first light emitting module mount 160, the roof 165 is coupled to the first light emitting module mount 160 to prevent intrusion of pollutants or moisture into the first light emitting module 161 mounted inside the first light emitting module cover 1164. In this manner, with the first light emitting module cover 1164, the insect trap according to an exemplary embodiment may prevent the first light emitting module 161, which is a pest attraction light source, from being damaged by foreign matter, such as dust, water, or moisture, thereby improving durability and lifespan of the pest attraction light source while improving pest attraction with the pest attraction light source.

For example, at least a portion of the seated portion 1266 may include a coupling portion 1267 formed in a stepped manner. The first light emitting module mount 160 may be formed with a stepped portion corresponding to a stepped portion 1269 defined by the seated portion 1266 and the coupling portion 1267, such that the first light emitting module cover 1164 can be securely coupled to the first light emitting module mount 160 through engagement between the stepped potions. Accordingly, with the first light emitting module cover 1164, the insect trap according to an exemplary embodiment may also prevent the pest attraction light source from being damaged by foreign matter, such as dust, water, or moisture, thereby improving durability and lifespan of the pest attraction light source while further improving pest attraction by the pest attraction light source.

In an exemplary embodiment, a packing member formed of, for example, rubber may be further mounted between the first light emitting module mount 160 and the first light emitting module cover 1164, specifically between the seated portion 1266 and the first light emitting module mount 160 or between the coupling portion 1267 and the first light emitting module mount 160. With the packing member, the first light emitting module cover 1164 can be more securely coupled to the first light emitting module mount 160. Accordingly, with the first light emitting module cover 1164, the insect trap according to an exemplary embodiment may further prevent the pest attraction light source from being damaged by foreign matter, such as dust, water, or moisture, thereby improving durability and lifespan of the pest attraction light source while further improving pest attraction with the pest attraction light source.

The first light emitting module cover 164 or 1164 may have an uneven surface and/or may further include a separate diffuser to refract or diffuse light from the first light emitting module 161. The separate diffuser may be attached to the front side or rear side of the first light emitting module cover 164 or 1164 or may be disposed in front or rear of the first light emitting module cover 164 or 1164. Insects tend to be more strongly attracted to refracted or diffused light than to direct light. Accordingly, with the aforementioned structure, light from the first light emitting module 161 may be refracted or diffused, rather than directly passing through the first light emitting module cover 1164, thereby improving insect attraction efficiency.

First Light Emitting Module 161, 261, 361

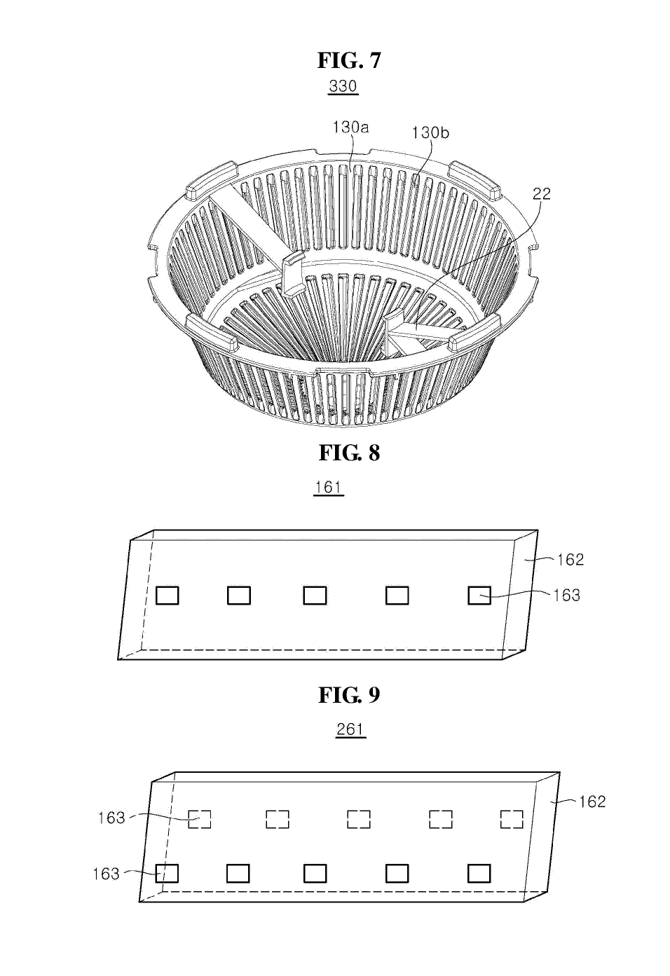

FIG. 8, FIG. 9, and FIG. 10 are views of first light emitting modules 161, 261, 361 according exemplary embodiments.

The first light emitting module 161, 261, or 361 may provide at least one of UV light, visible light, and infrared light. With regard to wavelengths to which insects are attracted, it has been reported that flies and leafhoppers prefer light having a wavelength of about 340 nm or about 575 nm, and moths and mosquitoes prefer light having a wavelength of about 366 nm. In addition, other general insect pests have been reported to prefer light having a wavelength of about 340 nm to about 380 nm.

The first light emitting module 161, 261, or 361 emits light having a wavelength of about 340 nm to about 390 nm. In an exemplary embodiment, the first light emitting module may emit light having a wavelength of about 365 nm that may provide high attraction to insects, especially mosquitoes, and is less harmful to the human body.

The first light emitting module 161, 261, or 361 may include at least one first light emitting diode chip 163, or at least one first light emitting diode package mounted on a first light emitting module substrate 162. The light emitting diode chips or the first light emitting diode packages may be arranged in zigzag pattern to prevent the first light emitting module substrate 162 from overheating.

The first light emitting module substrate 162 may be provided in the form of a panel having a predetermined thickness, and may include a printed circuit board therein with an integrated circuit or a wire. For example, the first light emitting module substrate 162 may be a printed circuit board having a circuit pattern disposed in a region where the first light emitting diode chip 163 is to be mounted. In addition, the first light emitting module substrate 162 may be formed of a metal, a semiconductor, a ceramic, or a polymer.

The first light emitting module 161, 261, or 361 may have a structure, in which the first light emitting diode chip 163 is mounted on a PCB having a long flat plate-like shape, for example. The first light emitting diode chip 163 may be provided in plural, for example, 4 to 10 light emitting diode chips spaced apart from each other in a longitudinal direction of the PCB. The PCB may be provided on the other surface thereof with a heat dissipation fin that may dissipate heat generated by the first light emitting diode chip 163, and the first light emitting module 161, 261, or 361 may be provided at both ends thereof with a terminal connected to a power supply to supply electric power to the PCB.

The first light emitting module 161, 261, 361 may have a light output of about 1000 mW to about 1,500 mW at an input voltage of about 10 V to about 15 V and at an input current of about 75 mA to about 100 mA. Within this range, the first light emitting module can emit UV light having a wavelength of 365 nm with an intensity harmless to the human body, thereby effectively attracting insects without any harm to the human body while minimizing power waste.

In the first light emitting module 161, 261, or 361, first light emitting diode chips 163 or first light emitting diode packages mounted on one surface of the first light emitting module substrate 162 may be arranged to not overlap the first light emitting diode chips 163 or the first light emitting diode packages mounted on the other surface of the first light emitting module substrate 162, for example, in multiple rows or in zigzags, without being limited thereto. Accordingly, the insect trap 1000 according to an exemplary embodiment can minimize power consumption while greatly expanding a light radiation range, and can also effectively dissipate heat generated by the first light emitting diode chip 163, thereby improving durability of the first light emitting module 161, 261, or 361.

The first light emitting diode chip 163 or the first light emitting diode package may provide spot emission. For example, the first light emitting diode chip 163 or the first light emitting diode package may include a plurality of spot light sources spaced apart from each other by about 2 mm to about 50 mm.

As electric energy supplied to the first light emitting module 161, 261, or 361 is converted into light energy and heat energy, and heat is generated by the first light emitting diode chip 163. According to an exemplary embodiment, the temperature measured in a space within 5 mm from the first light emitting diode chip 163 may range from about 30° C. to about 60° C. Since insects, especially mosquitoes, are strongly attracted to a temperature of about 38° C. to 40° C., which is similar to human body temperature, the insect trap 1000 can strongly attract insects using heat generated by the light emitting module 161, 261, or 361, in addition to UV light emitted from the light emitting module 161, 261, or 361.

Since the first light emitting module 161, 261, or 361 has a light output of about 1000 mW to about 1,500 mW at an input voltage of about 10 V to about 15 V and at an input current of about 75 mA to about 100 mA, and the first light emitting diode chips 163 or the first light emitting diode packages on one surface of the first light emitting module substrate 162 may not overlap the first light emitting diode chips 163 or the first light emitting diode packages on the other surface of the first light emitting module substrate 162, the insect trap 1000 according to an exemplary embodiment can emit light that is harmless to the human body and highly effective in attracting insects, while minimizing power consumption, and can also generate heat to make the temperature around the insect trap 1000 suitable for insect attraction.

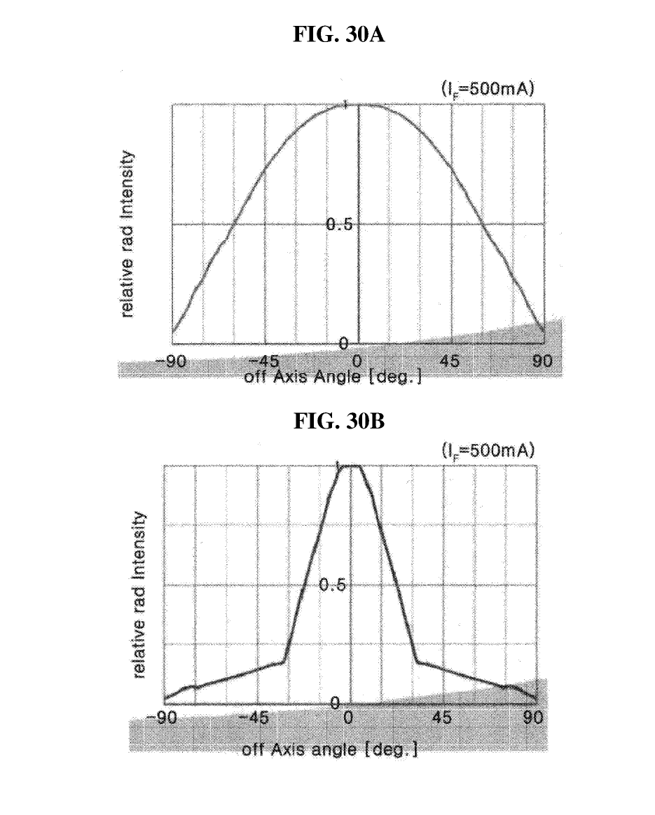

The insect trap according to an exemplary embodiment may include any one of first light emitting modules 1162, 1262, 1362, 1462, 1562, and 1662 according to exemplary embodiments to provide a sufficiently wide light emission angle and a longer light radiation range to more effectively attract insects, especially mosquitoes, which will be described in more detail with reference to FIG. 29 to FIG. 34.

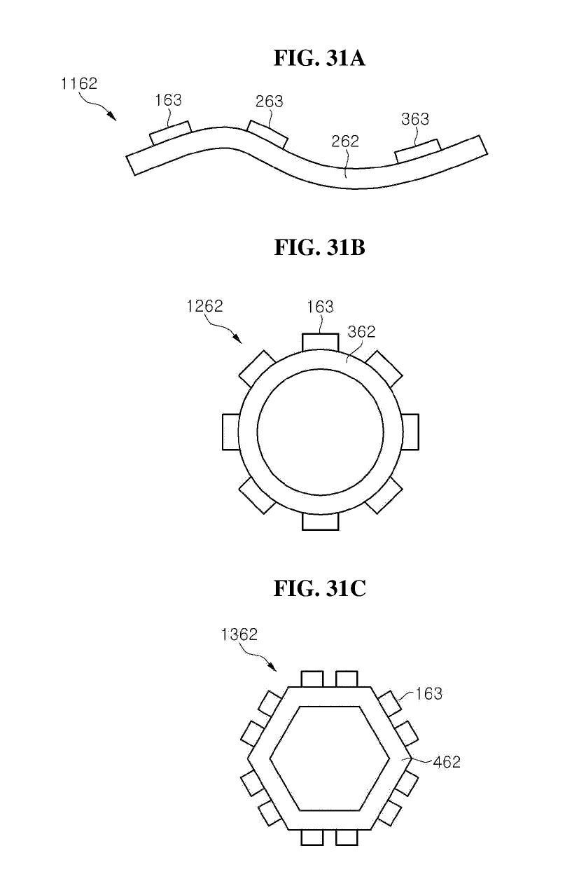

FIG. 29A and FIG. 29B are views schematically showing the light emission angle and light radiation range of first light emitting diode chips according to exemplary embodiments. FIG. 30A shows the light emission angle of the first light emitting diode chip of FIG. 29A, and FIG. 30B shows the light emission angle of the first light emitting diode chip of FIG. 29B.

Referring to FIG. 29 to FIG. 31, a plurality of first light emitting diode chips 163, 263, 363 mounted on the respective first light emitting module 161, 261, 361 may have different light emission angles. The first light emitting diode chip 163 may have any light emission angle and light radiation range, and may include, for example, the first light emitting diode chips 263, 363. Hereinafter, the first light emitting diode chip 163 may be interchangeable with 263, 363, as shown in FIGS. 29A and 29B. As used herein, the term “light emission angle” may refer to a region having a relative rad intensity of about 40% or more, for example, about 50% or more. Referring to FIG. 29A and FIG. 30A, the first light emitting diode chip 263 may have a light emission angle of about 100° to about 140°. Referring to FIG. 29B and FIG. 30B, the first light emitting diode chip 363 may have a light emission angle of about 40° to about 80°. The first light emitting diode chips 263, 363 may have different light radiation ranges. For example, the first light emitting diode chip 363 having a narrower light emission angle than the first light emitting diode chip 263 may have a longer light radiation range than the first light emitting diode chip 263. In particular, in the insect trap according to an exemplary embodiment, the first light emitting diode chips 163, 263, 363, having different in light emission angle and light radiation range, are mounted on the respective first light emitting modules 161, 261, 361 to provide both a wide light emission angle and a long light radiation range, thereby improving mosquito attraction with light and trapping efficiency.

Referring to FIGS. 29A and 29B, the first light emitting diode chip 263 or 363 may include a light emitting chip 263a or 363a, a light exit portion 263b or 363b, a flange 263c or 363c, and a substrate 263d or 363d. The light exit portion 263b or 363b is a portion through which light from the light emitting chip 263a or 363a passes, and may be formed by resin molding to at least partially contact and cover upper and side surfaces of the light emitting chip 263a or 363a. The light exit portion 263b or 363b may further include a light incident portion, which is an empty space between the light emitting chip 263a or 363a and the light exit portion 263b or 363b. In addition, the light exit portion 263b or 363b may be configured to allow only light from the upper surface of the light emitting chip 263a or 363a to exit therethrough, or to allow light from the upper and side surfaces of the light emitting chip 263a or 363a to exit therethrough. The flange 263c or 363c may be formed flat at the periphery of the light exit portion 263b or 363b, and may have a shape different from the light exit portion 263b or 363b convexly protruding from the substrate 263d or 363d, and may be formed of the same material as the light exit portion 263b or 363b. With the flange 263c or 363c provided to the first light emitting diode chip 263 or 363, it is possible to enhance adhesion of a material for the light exit portion 263b or 363b, for example, a silicone resin, to the substrate 263d or 363d, while preventing moisture intrusion into the light emitting chip 263a or 363a.

For example, the plurality of first light emitting diode chips 263, 363 may include first light emitting diode chips 263, 363 having light exit portions with different widths, such as the two first light emitting diode chips 263 363 having light exit portions with different widths r, r′, respectively. More specifically, the two first light emitting diode chips 263 363 having light exit portions with different widths r, r′, may be alternately arranged. As used herein, direction of the width of the light exit portion 263b or 363b may refer to the x-axis direction, rather than the y-axis direction shown in FIGS. 29A and 29B, and may be the longest distance among distances between lowermost points of the light exit portion 263b or 363b. For example, the lowermost points of the light exit portion 263b or 363b may be boundary points between the flange 263c or 363c and the light exit portion 263b or 363b. Even when the first light emitting diode chips 263, 363 include the same light emitting chip 263a or 363a, if the respective exit portions have different widths r, r′, the first light emitting diode chips 263, 363 may have different light emission angles. When the light exit portion has a relatively large width r as shown in FIG. 29A, the light emission angle may be wider than when the light exit portion has a relatively small width r′. As described above, a first light emitting diode chip having a narrower light emission angle has a longer light radiation range than a first light emitting diode chip having a wider light emission angle. In the insect trap according to an exemplary embodiment, the plurality of first light emitting diode chips 263, 363, have light exit portions with different widths r, r′, such that the first light emitting diode chips 263, 363 have different light emission angles and different light radiation ranges, is mounted on the first light emitting module 161, 261, or 361, whereby the first light emitting module 161, 261, or 361 can provide a wide light radiation area and a long light radiation range, thereby improving mosquito attraction with light and trapping efficiency.

For example, the plurality of first light emitting diode chips 263, 363 may include respective first light emitting diode chips 263, 363, respectively having light exit portions with different heights, for example, two first light emitting diode chips 263, 363, respectively having light exit portions with different heights h, h′. More specifically, the two first light emitting diode chips 263, 363, respectively having light exit portions with different heights h, h′ may be alternately arranged. As used herein, direction of the height h, h′ of the light exit portion may refer to the y-axis direction rather than the x-axis direction shown in FIGS. 29A and 29B, and may be the shortest distance from a lowermost point of the light exit portion 263b or 363b to a central point of an upper surface of the light emitting chip 263a or 363a. Even when the first light emitting diode chips 163, 263, 363 include the same light emitting chip 263a or 363a, if the respective exit portions have different widths h, h′, the first light emitting diode chips may have different light emission angles. When the light exit portion has a relatively large height h′ as shown in FIG. 29B, the light emission angle may be narrower than when the light exit portion has a relatively small height h. As described above, a first light emitting diode chip having a narrower light emission angle has a longer light radiation range than a first light emitting diode chip having a wider light emission angle. In the insect trap according to an exemplary embodiment, the plurality of first light emitting diode chips 263, 363, respectively have light exit portions with have different heights h, h′, such that the first light emitting diode chips 263, 363 have different light emission angles and different light radiation ranges, is mounted on the first light emitting module 161, 261, or 361, whereby the first light emitting module 161, 261, or 361 can provide a wide light radiation area and a long light radiation range, thereby improving mosquito attraction with light and trapping efficiency.

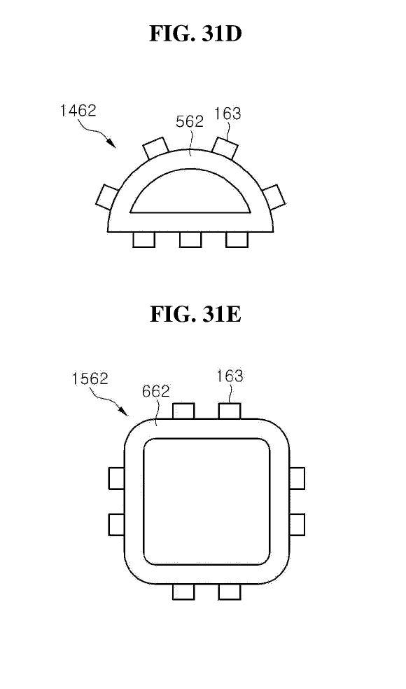

FIG. 31A to FIG. 31E are views of first light emitting module substrates according to exemplary embodiments.

Referring to FIGS. 31A to 31E, the insect trap according to exemplary embodiments may include various types of first light emitting module substrates 1162, 1262, 1362, 1462, 1562.

Referring to FIG. 31A, a first light emitting module 1162 may have a structure in which the first light emitting diode chips 163, 263, 363 are mounted on a flexible substrate 262. The first light emitting diode chips 163, 263, 363 may have the same or different light emission angles and light radiation ranges. The flexible substrate 262 may be entirely or partially bent. With the flexible substrate 262, which can be bent according to the shape of a space in which the first light emitting module 1162 is to be disposed, it is possible to make better use of a space in the first light emitting module mount 160 or 1160, while the insect trap can more effectively attract insects, especially mosquitoes, thereby exhibiting improved insect trapping efficiency by varying the shape of the flexible substrate 262 depending on usage environments.

Referring to FIG. 31B, a first light emitting module 1262 may have a structure in which the first light emitting diode chips 163, 263, 363 are mounted on a substantially circular substrate, for example, a center-perforated circular substrate 362. The first light emitting diode chips 163, 263, 363 may have the same or different light emission angles and light radiation ranges. In this manner, the first light emitting module 1262 can radiate light in all directions, whereby the insect trap can more effectively attract insects, especially mosquitoes therearound, thereby exhibiting improved insect trapping efficiency.

Referring to FIG. 31C, a first light emitting module 1362 may have a structure in which the first light emitting diode chips 163, 263, 363 are mounted on a polyhedral substrate 462. The first light emitting diode chips 163, 263, 363 may have the same or different light emission angles and light radiation ranges. For example, first light emitting diode chips 163, 263, 363 having different light emission angles and different light radiation ranges may be mounted on each surface of the substrate 462. With the polyhedral substrate 462, the first light emitting module 1362 can radiate light in all directions while first light emitting diode chips 163, 263, 363 having the same or different light emission angles and light radiation ranges depending on usage environments can be mounted on each surface of the substrate 462, such that the insect trap can more effectively attract insects, especially mosquitoes, thereby exhibiting improved insect trapping efficiency.

Referring to FIG. 31D, a first light emitting module 1462 may have a structure in which the first light emitting diode chips 163, 263, 363 are mounted on a substrate 562 having at least one arc. The first light emitting diode chips 163, 263, 363 may have the same or different light emission angles and light radiation ranges. For example, the substrate 562 may be a substantially D-shaped or substantially half-moon-shaped substrate having one arc and one plane. With the substrate 562 having at least one arc, the first light emitting module 1462 allows light from the arc to be radiated to a region requiring wide light radiation, and allows light from the plane to be radiated to a region requiring concentrated light radiation, such that the insect trap can more effectively attract insects, especially mosquitoes, thereby exhibiting improved insect trapping efficiency.

Referring to FIG. 31E, a first light emitting module 1562 may have a structure in which the first light emitting diode chips 163, 263, 363 are mounted on a polyhedral substrate 1562 with at least one rounded or beveled corner. The first light emitting diode chips 163, 263, 363 may have the same or different light emission angles and light radiation ranges. With the polyhedral substrate 1562 with at least one rounded or beveled corner, when the first light emitting module 1562 is inserted into and mounted on the first light emitting module mount 160 or 1160, a wider contact area between the first light emitting module and the first light emitting module mount can be secured than with a substrate having no rounded or beveled corner, such that stress due to vibration of the suction fan 150 can be easily dispersed, thereby improving durability of the first light emitting module 1562.

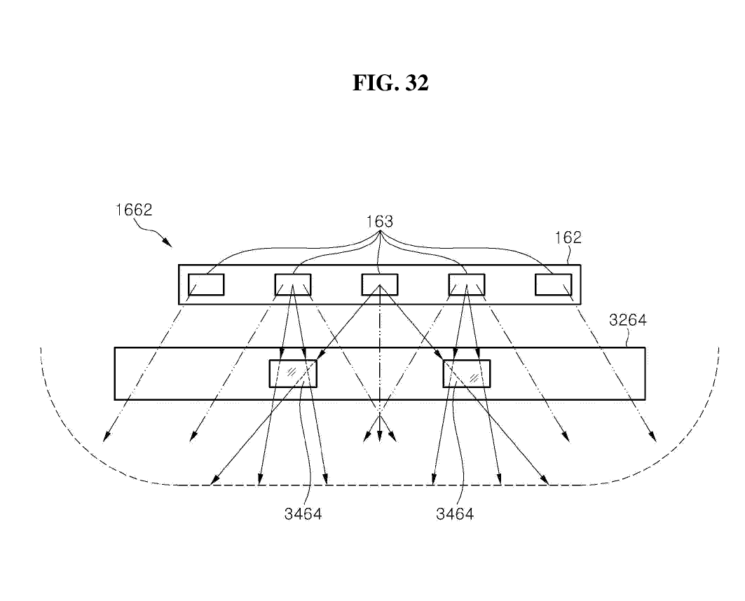

FIG. 32 is a view of a first light emitting module and a first light emitting module cover according to an exemplary embodiment.

Referring to FIG. 2 and FIG. 32, the first light emitting module mount 160 may include a first light emitting module cover 3264 mountable thereon to face at least a portion of a first light emitting module 1662. The first light emitting module 1662 may be formed of a substantially the same material forming the first light emitting module cover 164. In addition, the first light emitting module cover 3264 may include a light emission angle conversion portion 3464 formed at least a portion thereof. The light emission angle conversion portion 3464 may include a light diffusion portion or a light converging portion. Insects, especially mosquitoes, are known to be more strongly attracted by refracted light. The light emission angle conversion portion 3464 formed at least a portion of the first light emitting module cover 3264 can refract or diffuse light passing therethrough, such that the insect trap can more effectively attract insects, thereby exhibiting improved insect trapping efficiency. In addition, the light emission angle conversion portion 3464 may be disposed in front of a specific first light emitting diode chip 163, 263, or 363, as shown in FIG. 32. Further, even when first light emitting diode chips 163, 263, 363 mounted on a single printed circuit board have the same light emission angles and light radiation ranges, the light emission angle conversion portion 3464 can provide substantially the same effect as mounting a plurality of first light emitting diode chips 163, 263, 363 having different light emission angles and light radiation ranges on the substrate, as described above with reference to FIG. 29 and FIG. 30, such that the insect trap can more effectively attract insects, especially mosquitoes, thereby exhibiting improved insect trapping efficiency. In some exemplary embodiments, the light emission angle conversion portion 3464 may not be provided to the first light emitting module cover 3264, and may be included in the first light emitting diode chip. For example, when a light emitting diode (LED) is used as the first light emitting diode chip 163, 263, or 363, the light emission angle conversion portion 3464 may be included in at least a portion of the light incident portion or in at least a portion of the light exit portion 263b or 363b. Alternatively, a separate light emission angle conversion portion may be further included in the light exit portion 263b or 363b. With the light emission angle conversion portion 3464 provided to at least a portion of the first light emitting module cover 3264 or included in the first light emitting diode chip 163, 263, or 363, it is possible to provide substantially the same effect as mounting a plurality of first light emitting diode chips 163, 263, 363 having different light emission angles and light radiation ranges on the substrate, as described above with reference to FIG. 29 and FIG. 30, such that the insect trap can more efficiently attract insects, especially mosquitoes, thereby exhibiting improved insect trapping efficiency.

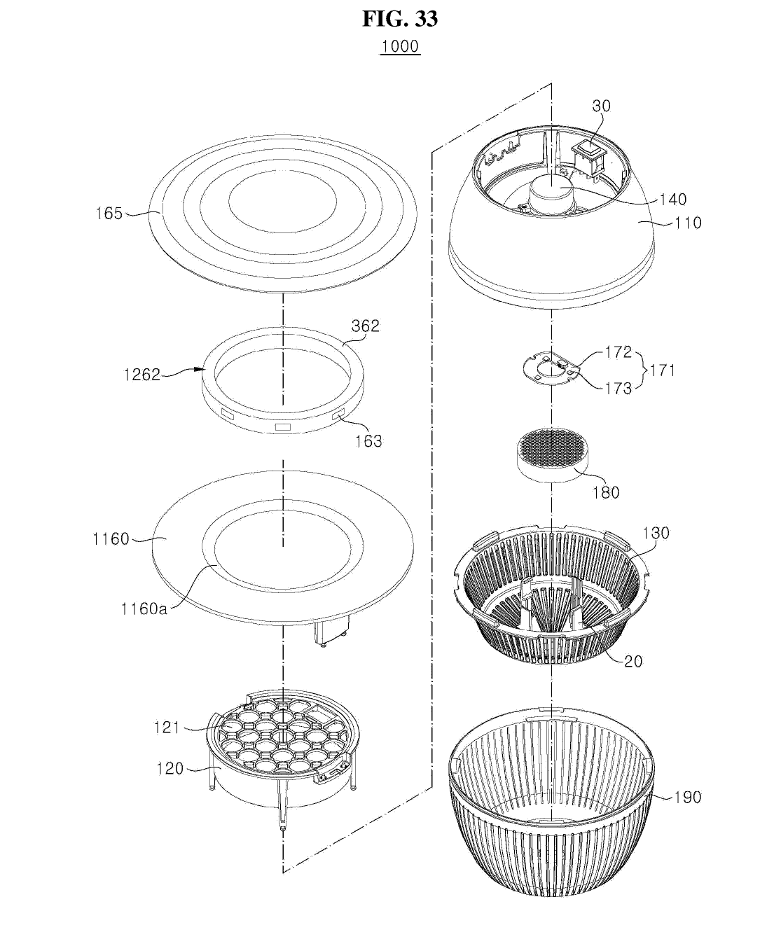

FIG. 33 is an exploded perspective view of an insect trap according to another exemplary embodiment.

Referring to FIG. 33, a first light emitting module mount 1160 may include a first light emitting module insertion groove 1160a. The shape of the first light emitting module insertion groove 1160a may vary depending upon the shape of the first light emitting module substrate 162, 262, 362, 462, 562, or 662 described above. For example, when a circular first light emitting module 1262 is used, the first light emitting module insertion groove 1160a may have a substantially circular shape. With the first light emitting module insertion groove 1160a that may be formed to have various shapes to receive various first light emitting modules 161, 261, 361, 1162, 1262, 1362, 1462, 1562, 1662 described above, the first light emitting module mount 1160 can allow various first light emitting module 161, 261, 361, 1162, 1262, 1362, 1462, 1562, 1662 to be mounted thereon depending on usage environments, such that the insect trap can more efficiently attract insects, especially mosquitoes, thereby exhibiting improved insect trapping efficiency.

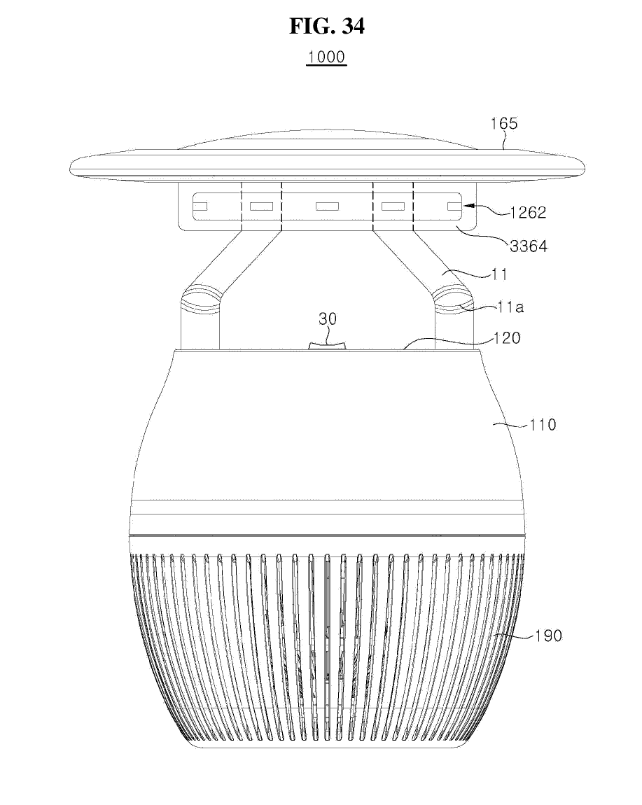

FIG. 34 is a side view of an insect trap according to an exemplary embodiment.

Referring to FIG. 34, the insect trap 1000 may include a first light emitting module mount support 10 or 11. The first light emitting module mount support 10 or 11 may support the first light emitting module mount 160 or 1160 on the main body 110 in a spaced apart manner, in which the first light emitting module mount support 10 or 11 may be connected to a lower surface of the first light emitting module mount 160 or 1160. The first light emitting module mount support 10 or 11 may be disposed so as not to block light from the first light emitting module 161, 261, 361, 1162, 1262, 1362, 1462, 1562, or 1662. For example, when the first light emitting module 161, 261 or 361 includes the plate-shaped substrate 162, as shown in FIG. 1 to FIG. 4, the first light emitting module mount support 10 or 11 may be disposed at both sides of the first light emitting module substrate 162 so as not to block light from the first light emitting diode chip 163 on the plate-shaped substrate 162. When the first light emitting module substrate 362, 462, or 662 of FIGS. 31B, 31C, 31E, and FIG. 33 are used to allow light radiation in all directions, the first light emitting module mount support 10 or 11 may be disposed inside a region defined by the first light emitting module substrate 362, 462, or 662 so as not to block light from the first light emitting diode chip 163, 263, or 363, as shown in FIG. 34. In an exemplary embodiment, when the D-shaped or half-moon-shaped substrate of FIG. 31D is used, the first light emitting module mount support 10 or 11 may be disposed at both sides of the first light emitting module substrate 162 or may be disposed inside a region defined by the first light emitting module substrate 562. In particular, by employing the first light emitting module 1162, 1262, 1362, 1462, or 1562 capable of emitting light in all directions and by positioning the first light emitting module mount support 10, 11 inside a region defined by the first light emitting module substrate 362, 462, 562, or 662, the insect trap can more efficiently attract insects, especially mosquitoes, thereby exhibiting improved insect trapping efficiency.

In addition, referring to FIG. 34, the first light emitting module mount support 11 may further include a length adjustment portion 11a. The length adjustment portion 11a may be entirely or partially bent, and may be formed of a soft material or may include a foldable or telescopic member. In addition, the length adjustment portion 11a is movable vertically and horizontally with respect to the main body 110, thereby allowing adjustment of the installation angle of the first light emitting module mount 160 or 1160. With the length adjustment portion 11a allowing adjustment of the length of the first light emitting module mount support 11, the installation height or angle of the first light emitting module 161, 261, 361, 1162, 1262, 1362, 1462, 1562, or 1662 can be adjusted depending on installation environments by a user, such that the insect trap can more efficiently attract insects, especially mosquitoes, thereby exhibiting improved insect trapping efficiency.

Second Light Emitting Module Mount 170

Referring to FIG. 3 and FIG. 4, the insect trap 1000 according to an exemplary embodiment may include the second light emitting module mount 170 disposed between the suction fan 150 and the insect collection unit 190, on which the second light emitting module 171 may be mounted thereon.

The shape of the second light emitting module mount 170 is not particularly limited, and may be disposed between the insect collection unit 190, specifically the photocatalyst filter mount 20 and the suction fan 150.

The second light emitting module mount 170 may be supported by one or more supports extending from a lower end of the main body 110 or from the air collection unit 130, or by one or more supports extending from the photocatalyst filter mount 20.

In addition, the second light emitting module mount 170 may be detachable from the one or more supports, may be formed at the lower end of the main body 110 as a part of the main body 110, or may be formed at the upper end of the photocatalyst filter mount 20 as a part of the air collection unit 130 or as a part of the photocatalyst filter mount 20. In an exemplary embodiment, the second light emitting module mount 170 is formed at the lower end of the main body 110 as a part of the main body 110 to be easily controlled in operation by a switch 30 along with the first light emitting module 161 and the suction fan 150. The second light emitting module mount 170 be formed of substantially the same material as the main body 110 to reduce processing costs.

When disposed at the lower end of the main body 110, the second light emitting module mount 170 may be supported by one or more supports extending from a lower inner wall portion of the main body 110. The supports may be provided in the form of a lattice so as not to interfere with an air flow created by the suction fan 150, and, specifically, may be formed of a substantially circular member and a substantially radial member. More specifically, the second light emitting module mount 170 may be formed of a plurality of substantially circular members and radial members arranged at an angle of about 40 to about 90 degrees about the center of the second light emitting module mount 170.

The second light emitting module mount 170 may be disposed at the lower center of the main body 110 or under a hub of the suction fan 150 so as not to interfere with a pathway through which insects having passed through the suction fan 150 are collected into the insect collection unit 190. In addition, the second light emitting module mount 170 may be disposed under the suction fan 150 such that a surface of the second light emitting module 171, to which heat generated by the second light emitting diode chip 173 is transferred, for example, a surface of the second light emitting module 171 on which the second light emitting diode chip 173 is not mounted, faces the suction fan 150 so as to dissipate heat generated by the second light emitting module 171 using an air flow created by the suction fan, thereby improving the reliability and durability of the second light emitting module 171.

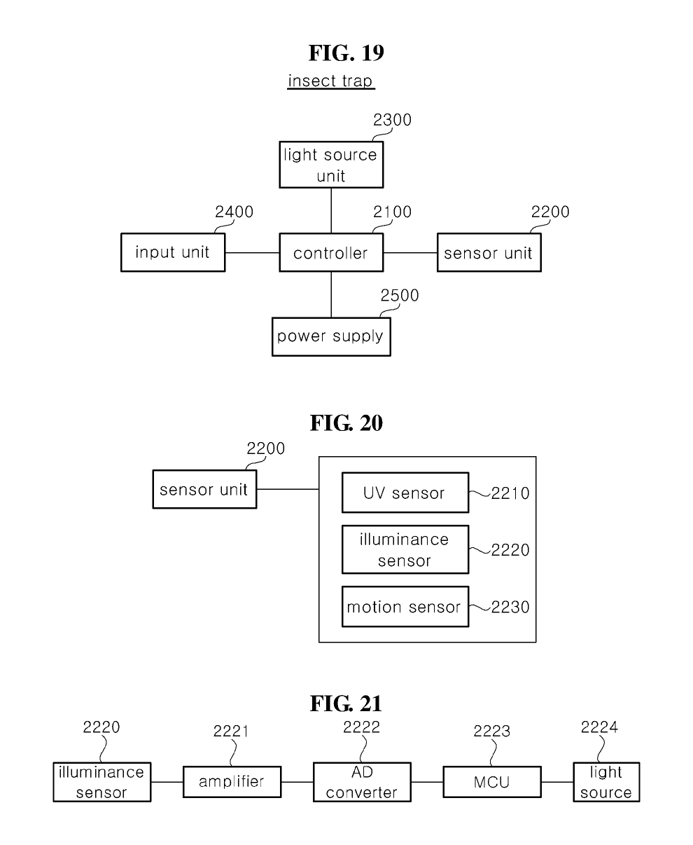

Referring to FIG. 17 to FIG. 18, the insect trap 1000 may further include a second protrusion 174 extending from a lower side of the second light emitting module mount 170. The second protrusion 174 surrounds the second light emitting module 171 mounted on the second light emitting module mount 170 to prevent light from the second light emitting module 171 from being radiated outside the insect trap 1000, thereby preventing reduction in insect attraction by the first light emitting module 161 while preventing insects from being captured in the photocatalyst filter 180.

In addition, a light reflective material may be coated on or applied to an inner surface of the second protrusion 174. With the second protrusion 174, the insect trap 1000 allows light from the second light emitting module 171 to be concentrated in the photocatalyst filter 180, thereby improving deodorization by the photocatalyst filter 180 while improving carbon dioxide generation efficiency and thus exhibiting improved insect pest trapping efficiency, which will be described in more detail below.

Second Light Emitting Module 171

Referring to FIG. 4, the insect trap 1000 according to an exemplary embodiment may include the second light emitting module 171 mounted at the lower end of the second light emitting module mount 170 to emit light toward the photocatalyst filter 180.

The second light emitting module 171 may provide at least one of UV light, visible light, and infrared light.

The second light emitting module 171 may emit light having a wavelength of about 200 nm to about 400 nm. Particularly, when used for sterilization, the second light emitting module may emit light having a wavelength of about 200 nm to about 300 nm. In addition, the second light emitting module 171 may have a light output of about 500 mW to about 3000 mW at an input voltage of about 5 V to about 30 V and at an input current of about 50 mA to about 100 mA. When the wavelength of light from the second light emitting module 171 and the light output of the second light emitting module 171 fall within these ranges, reaction efficiency of the photocatalyst filter 180 can be improved.

The second light emitting module 171 may include at least one second light emitting diode chip 173 or at least one second light emitting diode package mounted on the second light emitting module substrate 172.

The second light emitting module 171 may include a second light emitting module substrate 172. For example, the second light emitting module substrate 172 may be disposed at the lower center of the main body 110, and may have a substantially circular shape so as not to interfere with a suction air flow created by the suction fan 150, without being limited thereto. In an exemplary embodiment, the second light emitting module substrate 172 may having an opening at the center thereof. More specifically, an electric wire may be connected to the second light emitting module 171 through the opening to connect the second light emitting module to a power supply terminal.

The second light emitting diode chip 173 or the second light emitting diode package may provide spot emission. For example, the second light emitting diode chip 173 or the second light emitting diode package may include a plurality of spot light sources, in which the spot light sources may be separated at a distance of about 2 mm to about 50 mm from one another.

The second light emitting diode chip 173 may be provided in plural, for example, 2 to 6, more specifically 2 to 4 second light emitting diode chips spaced apart from each other depending on the shape of the second light emitting module substrate 172.

In some exemplary embodiments, the second light emitting module 171 may emit UVC to sterilize the insect trap 1000 or to kill the insects captured in the insect collection unit 190.

Photocatalyst Filter Mount 20, 21, 22

Referring to FIG. 3 and FIG. 4, the insect trap 1000 according to an exemplary embodiment may include a photocatalyst filter mount 20 disposed under the second light emitting module mount 170, on which the photocatalyst filter 180 may be mounted thereon.

The photocatalyst filter mount 20 may have any suitable shape for allowing the photocatalyst filter 180 to be stably mounted thereon, and may be formed of one or more supports extending from the lower end of the main body 110 or from the air collection unit 130. In an exemplary embodiment, the photocatalyst filter mount 20 is formed by one or more supports extending from the air collection unit 130 to facilitate replacement of the second light emitting module 171 or the second light emitting diode chip 173 mounted on the second light emitting module mount 170.

FIG. 5 to FIG. 7 are views of air collection units 130, 230, 330 of the insect trap 1000 according exemplary embodiments.

Referring to FIG. 5 to FIG. 7, the photocatalyst filter mount 20, 21 or 22 may be formed of a plurality of supports extending from the air collection unit midsection 132, may be formed of a plurality of supports extending from the boundary between the air collection unit midsection 132 and the air collection unit inlet 131, or may be formed of a plurality of supports extending from upper and lower ends of the air collection unit inlet 131. However, the inventive concepts are not limited thereto, and the photocatalyst filter mount may be implemented in various forms conceivable from FIG. 5 to FIG. 7.

Photocatalyst Filter 180

Referring to FIG. 3 and FIG. 4, the insect trap 1000 according to an exemplary embodiment may include the photocatalyst filter 180 mounted on the photocatalyst filter mount 20.

The photocatalyst filter 180 may be a photocatalytic medium, and may include a material that provides a photocatalytic reaction. For example, the photocatalytic medium may include any one of titanium oxide (TiO₂), silicon oxide (SiO₂), tungsten oxide (WO₃), zirconium oxide (ZnO), strontium titanium oxide (SrTiO₃), niobium oxide (Nb₂O₅), iron oxide (Fe₂O₃), zinc oxide (ZnO₂), tin oxide (SnO₂), and combinations thereof. In an exemplary embodiment, the photocatalyst filter 180 may have a layered structure including titanium oxide (TiO₂).

The photocatalyst filter 180 may be obtained by coating a photocatalyst material on a medium that can allow passage of an air flow, such as metal foam or a porous ceramic.

The photocatalyst filter 180 can photocatalytically react with UV light of about 200 nm to 400 nm emitted from the second light emitting module 171. When UV light is absorbed by the photocatalytic medium, electrons (e) and holes (+) are generated on a surface of the photocatalytic medium and move to a surface of the photocatalyst. The generated electrons and holes can remove pollutants in air via redox reaction with the pollutants. In addition, the electrons generated on the surface of the photocatalyst react with oxygen present on the surface of the photocatalytic medium to generate superoxide anion radicals (•O₂—) and the holes react with hydroxyl groups (—OH) or moisture present on the surface of photocatalyst or in air to generate hydroxyl radicals (•OH—).

The resulting hydroxyl radicals can act as a strong oxidizing agent to provide sterilization, and can oxidize and decompose organic pollutants and odorous substances in air introduced into the insect trap 1000 into water and carbon dioxide.

In this manner, the insect trap 1000 according to an exemplary embodiment can provide sterilization and deodorization through a photocatalytic reaction in the photocatalyst filter 180 induced by UV light from the second light emitting module 171.

In addition, carbon dioxide, which is generated by the photocatalytic reaction, is known as a substance highly effective in attracting mosquitoes, and, in order to promote generation of carbon dioxide, an attractant such as lactic acid, amino acid, sodium chloride, uric acid, ammonia or a proteolytic substance may be additionally provided to the photocatalyst filter 180. Here, the attractant may be applied to the photocatalyst layer in the photocatalyst filter 180, or may be periodically or aperiodically sprayed onto the photocatalyst layer, without being limited thereto. In this manner, the concentration of carbon dioxide can be increased, thereby further improving insect attraction.

With the second light emitting module 171 and the photocatalyst filter 180, the insect trap 1000 can provide both sterilization and deodorization while more effectively attracting insects, especially mosquitoes, using carbon dioxide generated by the photocatalytic reaction.

Switch 30

Referring to FIG. 3 and FIG. 4, the insect trap 1000 may further include a switch 30 to control a power supply system for the first light emitting module 161, the suction fan 150, and the second light emitting module 171.

The switch 30 may include one or a plurality of switches depending on power supply system modes. The switch 30 may be disposed at any suitable location for easy access by a user, for example, at the upper end or lower end of the first light emitting module mount 160, or at the upper end or side surface of the main body 110. In an exemplary embodiment, the switch 30 is disposed at the upper end of the main body 110 to reduce the distance to the first light emitting module 161, the suction fan 150, and the second light emitting module 171 electrically connected thereto and to increase frictional resistance of the insect trap 1000 upon pressing the switch 30 such that the insect trap 1000 can stably retain an original position thereof.

With the switch 30, the insect trap 1000 can individually control the first light emitting module 161, the suction fan 150, and the second light emitting module 171, such that the power supply system can be controlled according to a user preference or need.

Alternatively, with the switch 30, the insect trap 1000 may control the power supply system such that at least two selected from the group consisting of the first light emitting module 161, the suction fan 150, and the second light emitting module 171, and the rest component can be individually driven.

For example, the switch 30 may control the power supply system such that the second light emitting module 171 is driven, and the first light emitting module 161 and the suction fan 150 are optionally driven. In particular, upon operation of the switch 30 for power supply, the second light emitting module 171 may be driven at all times such that the insect trap 1000 can provide deodorization, while the first light emitting module 161 and the suction fan 150 may be optionally driven such that the insect trap 1000 can provide both deodorization and mosquito attraction.

As another example, the switch 30 may control the power supply system such that the first light emitting module 161 and the suction fan 150 are driven and the second light emitting module 171 is optionally driven. In particular, upon operation of the switch 30 for power supply, the first light emitting module 161 and the suction fan 150 may be driven at all times such that the insect trap 1000 can provide mosquito attraction, and the second light emitting module 171 may be optionally driven such that the insect trap 1000 can provide both deodorization and mosquito attraction, whereby utilization of the insect trap 1000 can be improved. In addition, the insect trap 1000 may be powered by an external power source via an electric wire connected thereto, or may be equipped with a portable energy storage unit to be used regardless of usage environments. In other exemplary embodiments, the insect trap 1000 may include: the main body 110; the insect passage unit 120 disposed on the main body 110 and allowing insects to pass therethrough; the air collection unit 130, 230 or 330 disposed under the main body 110; the suction fan 150 disposed between the air collection unit 130, 230 or 330 and the insect passage unit 120; the first light emitting module mount 160 disposed above the insect passage unit 120 and allowing the first light emitting module 161 to be mounted thereon; the insect collection unit 190 disposed under the air collection unit 130, 230 or 330 to collect insects; the second light emitting module mount 170 disposed between the suction fan 150 and the insect collection unit 190 and allowing the second light emitting module 171 to be mounted thereon; and the photocatalyst filter 180 disposed under the second light emitting module mount 170.

The first light emitting module 161 may be detachable from the first light emitting module mount 160 and the photocatalyst filter 180 may be detachable from the photocatalyst filter mount 20.

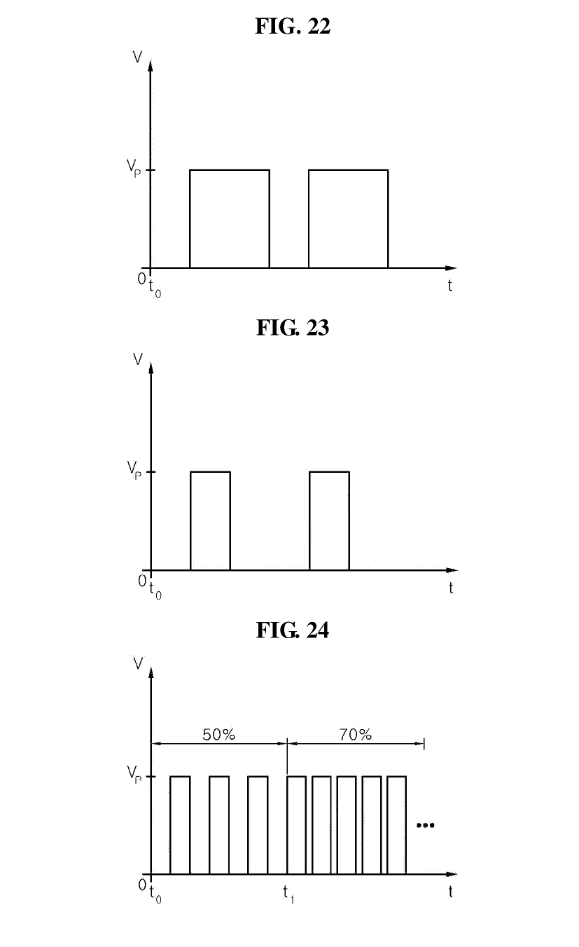

Hereinafter, an insect trap 2000 according to another exemplary embodiment will be described with reference to FIG. 19 to FIG. 28. An insect trap 2000 according to the illustrated exemplary embodiment further provides efficient power consumption and improved insect attraction, prevent a user from suffering dazzling to improve user friendliness, and allow the time to replace a luring light source to be checked in advance to maintain optimal insect attraction.

Conventional insect traps may have poor insect attraction in the daytime or when the illuminance of ambient light is high, harmful effects, such as causing a user in the vicinity of the insect trap to be dazzled by luring light, and difficulty in checking the time to replace a luring light source in advance, and thus, deteriorating insect attraction by luring light. An insect trap according to an exemplary embodiment may further include an illuminance sensor, a motion sensor, and a UV sensor.

FIG. 19 is a block diagram of an insect trap according to an exemplary embodiment.

Referring to FIG. 19, the insect trap 2000 may include a controller 2100, a sensor unit 2200, a light source unit 2300, an input unit 2400, and a power supply 2500.

The controller 2100 may control the operation of the insect trap 2000, for example, the light source unit 2300, based on input information. The controller 2100 may process at least part of information obtained from the sensor unit 2200 to provide the processed information to a user, or to control the operation of the light source unit 2300 based on the processed information.

The power supply 2500 supplies electric power to the insect trap 2000 and may be charged using a general AC power source or may include a battery. The power supply 2500 may include a filter, a rectifier, a switching converter, and an output. The filter prevents internal parts of the power supply 2500 from being damaged by noise on an input line and removes high-frequency noise over the audio band, thereby allowing stable current supply. The rectifier may include a rectifying circuit, a smoothing circuit, and a constant voltage circuit. The rectifying circuit filters only the positive polarity from an alternating current that oscillates at 50 Hz to 60 Hz per second, the smoothing circuit converts a pulsed current into a constant voltage using a rectifier capacitor to generate a constant voltage, and the constant voltage circuit may include a constant voltage diode producing a stable and constant direct current and a transistor. The switching converter may reduce electric power converted into a constant current by the rectifier into DC power. The output may supply power to the light source unit 2300.

The light source unit 2300 may be driven by receiving an operation signal from the controller 2100. For example, based on information detected by the sensor unit 2200, the controller 2100 may control power supply to the light source unit 2300 or control a method of driving the first light emitting module 161 and the second light emitting module 171.

The controller 2100 may control operation of a light source through control over current, voltage, pulse-width modulation, or phase-cut of the light source, depending upon whether illuminance of ambient light detected by an illuminance sensor 2220 falls within a predetermined illuminance range. For example, when the illuminance of ambient light detected by the illuminance sensor 2220 exceeds the predetermined illuminance range, the controller 2100 may increase light output by setting the duty ratio of a PWM signal to 70%, and, when the illuminance of ambient light detected by the illuminance sensor 2220 is below the predetermined illuminance range, the controller 2100 may reduce light output by setting the duty ratio of a PWM signal to 50%, thereby providing both efficient power consumption and high insect trapping efficiency while preventing a user from suffering inconvenience such as dazzling. As used herein, the term “duty ratio” may refer to a ratio of pulse-on duration to the total duration of one cycle, and a higher duty ratio may indicate a higher light output for a given period of time.

For example, when the temperature around the first light emitting module 161 or the second light emitting module 171 detected by a temperature sensor exceeds a predetermined temperature range, the controller 2100 may send a signal for cutting off power supply to the first light emitting module 161 or the second light emitting module 171 to the light source unit 2300 to prevent short circuit of the first light emitting module 161 or the second light emitting module 171, thereby improving durability and safety in use of the insect trap 2000.

In an exemplary embodiment, a display unit may be provided to indicate whether luminous intensity of the first light emitting module 161 or the second light emitting module 171 detected by a UV sensor 2210 falls within a predetermined luminous intensity range. In this manner, the insect trap 2000 may inform the user for a maintenance of the light source, for example, the first light emitting module 161, to be checked in advance, thereby maintaining optimal insect attraction with luring light, and thus, exhibiting improved insect trapping efficiency.

The luminous intensity of the first light emitting module 161 may be controlled according to information on user's proximity to the insect trap detected by a motion sensor 2230 detecting user's approach to the insect trap 2000. The motion sensor 2230 detects motion of a user around the insect trap 2000 or user's proximity to the insect trap 2000, and may include an ultrasonic sensor, an active infrared sensor, an optical sensor, and a passive infrared sensor that detects motion based on temperature change. For example, when user's proximity to the insect trap 2000 is less than a predetermined value, the controller 2100 may reduce the luminous intensity of the first light emitting module 161. In particular, when a user is in proximity to the insect trap 2000, the insect trap 200 can reduce luminous intensity of the first light emitting module 161 to prevent the user from being dazzled or damaged by the luring light.

The input unit 2400 may be capable of receiving user's input, and in an exemplary embodiments, may be provided in the form of a keyboard including various keys, such as character buttons, symbol buttons, special buttons and the like. In some exemplary embodiments, the input unit 2400 may be provided in the form of a simple switch. When the insect trap 2000 further includes a display unit, the display unit may be implemented as, for example, a touchscreen panel. In this case, the keyboard included in the input unit 2400 may be displayed in graphical form in an overlapping manner on the touchscreen. The position and transparency of a keyboard input window may be adjustable by a user, and the touchscreen panel may include an input means that also function as a display means, and also registers input by detecting the touch of a finger or stylus on a surface thereof.

The insect trap 2000 may further include a display unit. The display unit may display a window, for example, a graphical user interface (GUI), indicating information on operation of each component of the insect trap 2000, whose operation is controlled by the controller 2100, for example, information on operation of the first light emitting module 161 or the second light emitting module 171, or information detected by the sensor unit 2200. The display unit may be disposed, for example, on a front surface of the main body 110. The display unit may be implemented as a display window, such as an LCD or an LED, or may be implemented as a touchscreen panel serving as both an input means and a display means.

The insect trap 2000 may further include an alarm generator. When a value of data detected by the sensor unit 2200 exceeds or is less than a predetermined data value, the controller 2100 may send an alarm generation signal to the alarm generator. An alarm generated by the alarm generator may be a sound alarm or a light alarm, and may be issued from an electronic device of a user, for example, a portable terminal, through a communication module. For example, when the luminous intensity of the first light emitting module 161 or the second light emitting module 171 detected by the UV sensor 2210 is less than a predetermined luminous intensity range, the alarm generator may generate an alarm, which may include a light source replacement signal. As another example, when the temperature around the first light emitting module 161 or the second light emitting module 171 detected by the temperature sensor exceeds a predetermined temperature range, the alarm generator may generate an alarm, which may include a signal warning that the first warning light emitting module 161 or the second light emitting module 171 is at risk.

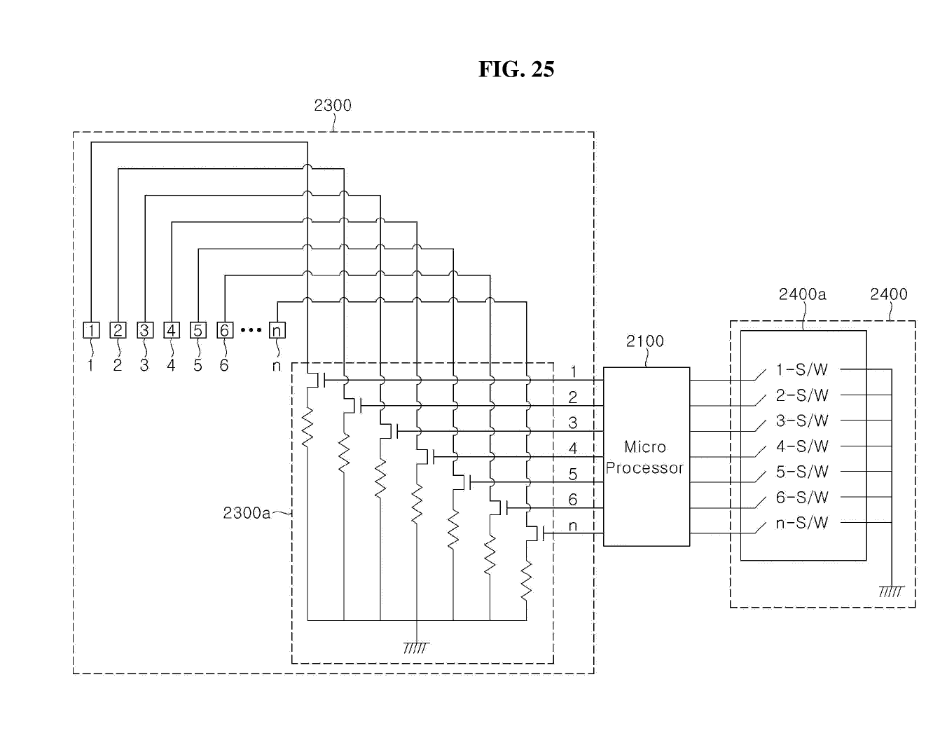

Referring FIG. 20, the sensor unit 2200 may include various sensors, such as, the UV sensor 2210, the illuminance sensor 2220, and the motion sensor 2230. Functions of each sensor are substantially the same as described above.

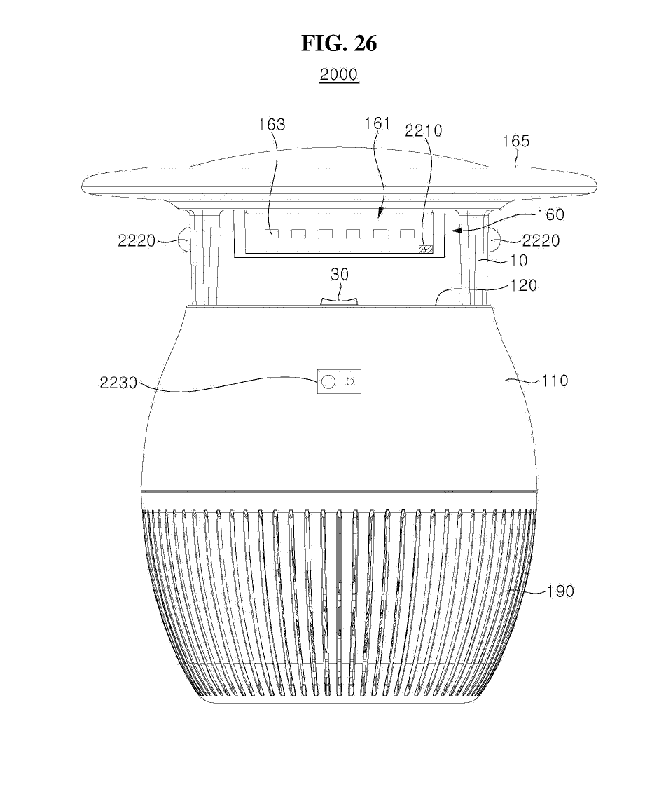

FIG. 21 is a block diagram illustrating light source control by an illuminance sensor according to an exemplary embodiment.

The insect trap 2000 can detect the illuminance of ambient light using the illuminance sensor 2220 to control operation of a light source 2224 based on the detected illuminance. Referring to FIG. 21, the insect trap 2000 may include the illuminance sensor 2220, an amplifier 2221, an analog-digital converter (ADC) 2222, a microcontroller unit (MCU) 2223, and the light source 2224. Here, the light source 2224 may refer to, for example, the first light emitting module 161.

When the illuminance of ambient light is detected by the illuminance sensor 2220 (ambient light sensor), before signal processing by the ADC, the amplifier (Amp) 2221 may perform signal processing, such that an analog signal can remain close to an original form without being altered by noise or the like, or can be under appropriate conditions for processing by the ADC. An analog signal processing by the amplifier 2221 may include amplification and filtering for noise cancellation. Further, for analog signal processing, an analog signal chain including the amplifier 2221 may be employed.

The MCU 2223 may include a CPU core, a memory, and a programmable input/output. A program for the MCU may be compiled and downloaded to the MCU as machine code. More specifically, the MCU 2223 may control operation of the light source 2224 based on ambient illuminance detected by the illuminance sensor 2220. In some exemplary embodiments, the MCU 2223 may be replaced by the controller 2100 or may be included in the controller 2100 as a subcomponent. For example, the MCU 2223 may control operation of the light source 2224 through control over the current, voltage, pulse-width modulation (PWM), or phase-cut of the light source 2224. For example, when the ambient illuminance detected by the illuminance sensor 2220 exceeds a predetermined ambient illuminance range, the MCU 2223 may control operation of the light source 2224, for example, light output of the light source, by generating an operation signal for increasing the driving current, driving voltage, or PWM duty ratio of the light source 2224.

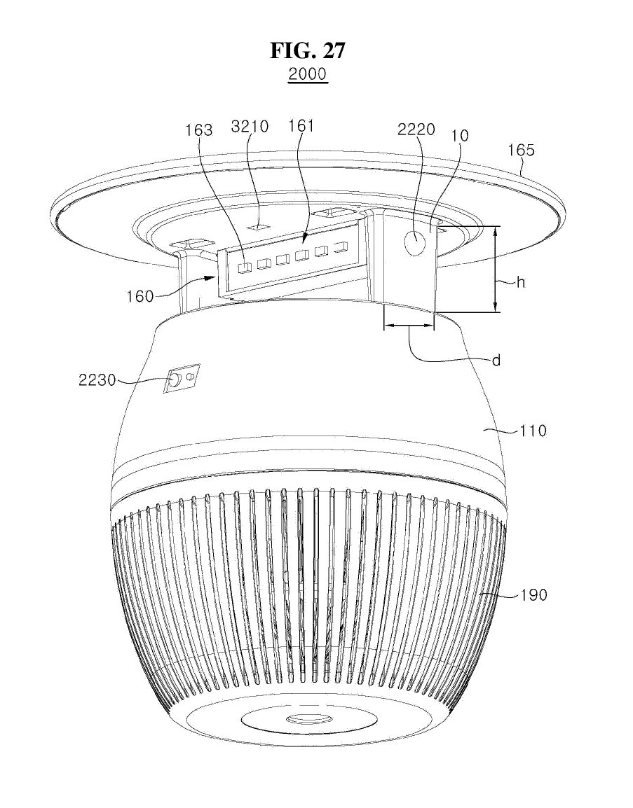

In an exemplary embodiment, the MCU 2223 may control the operation of the light source 2224 by PWM control. FIG. 22 to FIG. 24 are graphs showing waveform of driving voltage depending on PWM control for a light source.

Referring to FIG. 22 to FIG. 24, the driving voltage Vp applied to the light source 2224 may be controlled through PWM according to a PWM signal generated by the MCU 2223. PWM control may refer to a control method, in which a light source is driven by pulsed current rather than direct current, and allow driving current to be reduced for a given light output and allow a larger amount of current to flow than a continuous driving method, thereby increasing light radiation range. With PWM control over the light source 2224, the insect trap 2000 can more effectively attract insects, thereby exhibiting improved insect trapping efficiency while allowing efficient power consumption.

For example, in the daytime or in an environment of high ambient illuminance, a user may input a signal for increasing light output of the light source 2224 through the input unit 2400. Here, the controller 2100 may send a signal for increasing the duty ratio for PWM driving to the light source 2224, such that PWM control at a high duty ratio as shown in FIG. 22 is achieved to increase light output of the light source 2224. In this manner, the insect trap 2000 can more effectively attract insects, thereby exhibiting improved insect trapping efficiency.

For example, at night or in an environment of low ambient illuminance, a user may input a signal for reducing light output of the light source 2224 through the input unit 2400. The controller 2100 may send a signal for reducing the duty ratio for PWM driving to the light source 2224, such that PWM control at a low duty ratio as shown in FIG. 23 is achieved to reduce light output of the light source 2224, thereby preventing unnecessary power consumption and dazzling, and thus, improving user friendliness while providing optimal insect attraction with light and high insect trapping efficiency.

For example, when ambient illuminance changes, the light output of the light source 2224 may be automatically controlled according to the ambient illuminance detected by the illuminance sensor 2220 even when a user does not input a separate signal for controlling the light output of the light source 2224 through the input unit 2400. For example, referring to FIG. 24, when the ambient illuminance is low, the MCU 2223 may send a PWM signal having a relatively low duty ratio, for example, a duty ratio of 50%, to the light source 2224. When the ambient illuminance gradually increases and falls within a predetermined ambient illuminance range, the MCU 2223 may send a PWM signal having a relatively high duty ratio, for example, a duty ratio of 70%, to the light source 2224. In particular, through control over the duty ratio of a PWM signal, the insect trap 2000 allows the light output of the light source 2224 to be automatically controlled according to the ambient illuminance, without directly changing voltage or current, and thus can more effectively attract insects with light, thereby exhibiting high insect trapping efficiency while preventing unnecessary power consumption and dazzling, and thus, improving user friendliness.

The predetermined ambient illuminance range may include several sections. For example, when a value of ambient illuminance corresponds to section A, section B, section C, . . . , or section n, the MCU 2223 may send a PWM signal having a duty ratio of A′%, B′%, C′%, . . . , or n′% to the light source. In particular, the insect trap 2000 may perform control, such that light output of the light source can be changed stepwise according to change in ambient illuminance, and thus, can more effectively attract insects with light, thereby exhibiting high insect trapping efficiency while preventing unnecessary power consumption and dazzling, and thus, improving user friendliness.

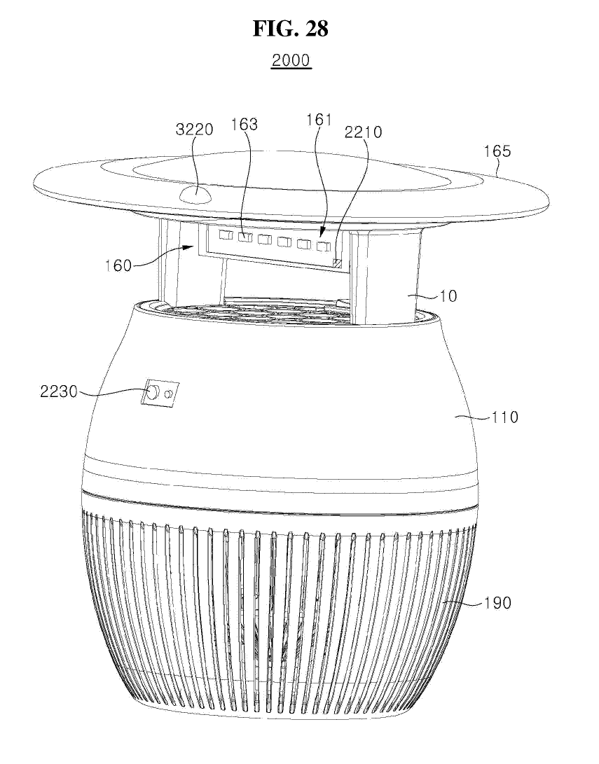

FIG. 25 is a schematic circuit diagram of a light source according to an exemplary embodiment.

Referring to FIG. 25, the light source 2224 may include a plurality of LEDs 1, 2, 3, 4, 5, 6, . . . , n, and the plurality of LEDs 1, 2, 3, 4, 5, 6, . . . , n may be individually driven. More specifically, the plurality of LEDs may be sequentially or alternately driven according to a control signal generated by the controller 2100. For example, when the ambient illuminance detected by the illuminance sensor 2220 is less than the predetermined ambient illuminance range, only a first LED 1, a third LED 3, a fifth LED 5, . . . , and an n^{th} LED n may be powered, and, when the ambient illuminance detected by the illuminance sensor 2220 exceeds the predetermined ambient illuminance range, all the LEDs 1, 2, 3, 4, 5, 6, . . . , n may be powered. In addition, when the predetermined ambient illuminance range includes several sections, the light source may be driven such that the number of LEDs 1, 2, 3, 4, 5, 6, . . . , n to which electric power is supplied can be increased stepwise.

An LED input switch 2400a may be a switch for selecting at least one of a first LED 1, a second LED 2, a third LED 3, a fourth LED 4, a fifth LED 5, a sixth LED 6, . . . , an n^{th} LED n, and may be divided into 1-S/W, 2-S/W, 3-S/W, 4-S/W, 5-S/W, 6-S/W, . . . , n-S/W. The input unit 2400 may be provided with a button, for example, to send electric signals to the switches in a collective or individual manner. In addition, the first to n^{th} LEDs 1, 2, 3, 4, 5, 6, . . . , n may be interconnected in groups of the same type, and may be connected to a light source driving circuit 2300a, which may be connected to the controller 2100 to be switched on/off.

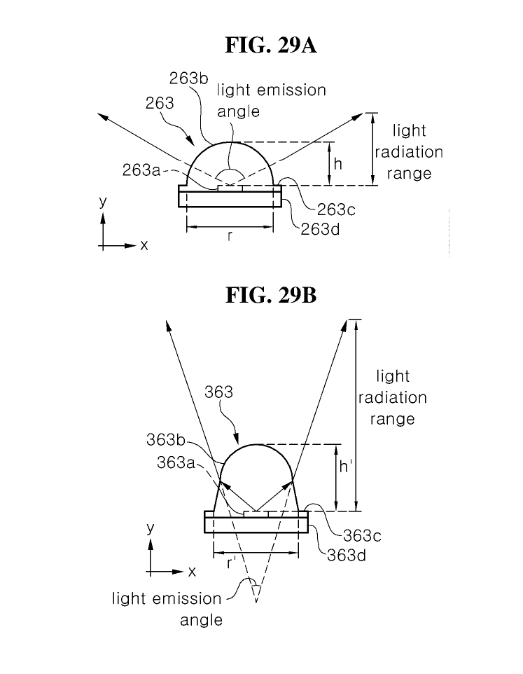

FIG. 26 to FIG. 28 are views of the insect trap according to exemplary embodiments, which may include the UV sensor 2210 or 3210, the illuminance sensor 2220 or 3220, and the motion sensor 2230. Each of the sensors described below may improve detection efficiency and avoid mutual interference, such that the insect trap 2000 can more effectively attract insects with light while allowing efficient power consumption, prevent dazzling to improve user friendliness, and allow time to replace a luring light source to be checked in advance, thereby providing optimal insect attraction with luring light.

Referring to FIG. 26 to FIG. 28, the motion sensor 2230 may be disposed in substantially the same direction as the traveling direction of light from the first light emitting diode chip 163 to detect information on user's proximity to the insect trap 2000. The operation of the motion sensor 2230 and a method of controlling the first light emitting diode chip 163 using the motion sensor 2230 are substantially the same as described above. For example, the motion sensor 2230 may be disposed above or below the first light emitting module 161 or may be disposed on the main body 110. With the motion sensor 2230 disposed in substantially the same direction as the traveling direction of light from the first light emitting diode chip 163, luminous intensity of the first light emitting module 161 can be reduced when a user is in proximity to the first light emitting module 161 rather than just being around the insect trap 2000, thereby maximizing user friendliness.

In addition, the UV sensor 2210 or 3210 may be disposed in the first light emitting module mount 160 to detect information on luminous intensity of light emitted from the first light emitting module 161, and operation of the UV sensor 2210 or 3210 and a method of displaying the information are substantially the same as described above. For example, as shown in FIG. 26, the UV sensor 2210 may be disposed on the first light emitting module substrate 162 to efficiently detect luminous intensity of light from the first light emitting module 161 while allowing a simple circuit configuration. Here, the insect trap 2000 may include a plate-shaped first light emitting module mount 160, and the first light emitting module 161 may be disposed at a lower side of the first light emitting module mount 160. For example, the UV sensor 3210 may be disposed on a lower surface of the plate-shaped first light emitting module mount 160, as shown in FIG. 27. In this manner, the UV sensor 2210 or 3210 can be directly irradiated with light from the first light emitting module 161 while being shielded from light from the outside of the insect trap 2000 by the first light emitting module mount 160, and thus, more efficiently detect luminous intensity of light from the first light emitting module 161.

In addition, the illuminance sensor 2220 or 3220 detects information on illuminance of ambient light of the insect trap 2000, and operation of the illuminance sensor 2220 or 3220 and a method of displaying the information are substantially the same as described above. For example, as shown in FIG. 26 to FIG. 27, the first light emitting module mount support 10 allows the first light emitting module mount 160 to be supported on the main body 110 in a spaced apart relationship, and is disposed at a side of the first light emitting module 161 so as not to block light from the first light emitting module 161. The illuminance sensor 2220 may be disposed on the first light emitting module mount support 10, for example, on a surface of the first light emitting module mount support 10 having a predetermined length ‘h’ and thickness ‘d’, which is opposite to a surface of the first light emitting module mount support facing the first light emitting module 161 so as not to be irradiated with light from the first light emitting module 161. For example, as shown in FIG. 28, the first light emitting module 161 is inserted into the first light emitting module mount 160 from above to be disposed on the lower surface of the first light emitting module mount 160. Here, the illuminance sensor 3220 may be disposed on the first light emitting module mount support 10, for example, on the roof 165, so as not to be irradiated with light from the first light emitting module 161. In particular, the illuminance sensor 2220 or 3220 can be shielded from light emitted from the first light emitting module 161 while being directly irradiated with light from the outside of the insect trap 2000, and thus, can more efficiently detect illuminance of ambient light.

Under dark conditions, conventional insect traps produce the same amount of light output as under light conditions, causing dazzling or excessive power consumption. The insect trap 2000 according to an exemplary embodiment can control light output to be below a predetermined value under dark conditions while maintaining optimal insect trapping efficiency.

As used herein, “dark conditions” may refer to conditions wherein illuminance of external light detected by the illuminance sensor ranges from about 0 lux to about 20 lux, or luminous intensity detected by the UV sensor ranges from about 0 mW to about 10 mW.

In an exemplary embodiment, the insect trap 2000 may be manually controlled to produce a light output of 100 mw or less under dark conditions, or may automatically control light output of the first light emitting module 161 to be reduced to 100 mW or less using the controller 2100, when illuminance of external light detected by the illuminance sensor 2220 or 3220 is input to the controller 2100 as information indicative of dark conditions.

In this manner, the insect trap 2000 according to an exemplary embodiment can prevent dazzling and excessive energy consumption while maintaining optimal mosquito trapping efficiency under dark conditions.

Hereinafter, an insect trap according to an exemplary embodiment will be described in more detail with reference to experimental examples.

Experimental Example 1—Control Over Angle of Vertical Section of the Air Collection Unit with Respect to the Ground.

In order to measure the frequency of escape of mosquitoes captured in the insect collection unit from the insect trap through the air collection unit outlet, depending on the angle of the vertical section of the air collection unit with respect to the ground, an experiment was conducted as follows:

More specifically, air collection units having an angle of 80°, 70°, 45°, and 30° with respect to the ground in vertical section were fabricated, and an air collection unit outlet of the air collection units had a substantially circular shape and a diameter of 50 mm, such that mosquitoes could easily escape therethrough. Then, an insect trap including the air collection unit was fabricated.

20 mosquitoes were put into an insect collection unit of the insect trap, followed by powering off the insect trap, and then the insect trap was allowed to stand for 15 hours, followed by measuring the number of mosquitoes escaping from the insect trap.

TABLE 1

| | | Number of | |
|---|---|---|---|
| | Number of | escaping | Average escape |
| Angle (°) | experiments | mosquitoes | rate (%) |
| 80 | 1 | 0 | 0 |
| | 2 | 0 | |
| | 3 | 0 | |
| 70 | 1 | 0 | 0 |
| | 2 | 0 | |
| | 3 | 0 | |
| 45 | 1 | 4 | 15 |
| | 2 | 3 | |
| | 3 | 2 | |
| 30 | 1 | 5 | 31.7 |
| | 2 | 8 | |
| | 3 | 6 | |

As shown in Table 1, it can be seen that the mosquito escape rate decreased with increasing angle of the vertical section of the air collection unit with respect to the ground. In addition, it was visually confirmed that some mosquitoes stuck to an inner wall or outer wall of the air collection unit.

Experimental Example 2—Control Over Vertical Length of Air Collection Unit Outlet

In order to measure the frequency of escape of mosquitoes captured in the insect collection unit from the insect trap through the air collection unit outlet, depending on the vertical length of the air corrector outlet, an experiment was conducted as follows:

More specifically, air collection units were fabricated, and an air collection unit outlet of the air collection units had a substantially circular shape and a diameter of 50 mm, such that mosquitoes could easily escape therethrough, and had a vertical length of 0 mm, 2 mm, 5 mm, or 10 mm. Then, an insect trap including the air collection unit was fabricated.

20 mosquitoes were put into an insect collection unit of the insect trap, followed by powering off the insect trap, and then the insect trap was allowed to stand for 15 hours, followed by measuring the number of mosquitoes escaping from the insect trap.

TABLE 2

| | | Number of | |
|---|---|---|---|
| | Number of | escaping | Average escape |
| Length (mm) | experiments | mosquitoes | rate (%) |
| 0 | 1 | 3 | 10.0 |
| | 2 | 2 | |
| | 3 | 1 | |
| 2 | 1 | 1 | 5.0 |
| | 2 | 2 | |
| | 3 | 0 | |
| 5 | 1 | 0 | 0.0 |
| | 2 | 0 | |
| | 3 | 0 | |
| 10 | 1 | 0 | 0.0 |
| | 2 | 0 | |
| | 3 | 0 | |

As shown in Table 2, it can be seen that the mosquito escape rate decreased with increasing vertical length of the air collection unit outlet. In addition, it was visually confirmed that some mosquitoes stuck to an inner wall or outer wall of the air collection unit outlet.

Experimental Example 3—Control Over Shape of Air Collection Unit Rib

In order to measure the frequency of escape of mosquitoes captured in the insect collection unit from the insect trap through the air collection unit outlet, depending on the shape of the air corrector rib, an experiment was conducted as follows:

More specifically, an air collection unit including an air collection unit rib having one rod-shaped portion with a predetermined length and width (a rectangular air collection unit rib) and an air collection unit including an air collection unit rib having two rod-shaped portions each with a predetermined length and width and partially overlapping each other in the width direction (a step-shaped air collection unit rib) were fabricated. Then, an insect trap according to the present invention including each of the air collection units was fabricated.

20 mosquitoes were put into an insect collection unit of the insect trap, followed by powering off the insect trap, and then the insect trap was allowed to stand for 15 hours, followed by measuring the number of mosquitoes escaping from the insect trap.

TABLE 3

| Shape of air | | Number of | |
|---|---|---|---|
| collection | Number of | escaping | Average escape |
| unit rib | experiments | mosquitoes | rate (%) |
| Rectangular shape | 1 | 0 | 5 |
| | 2 | 1 | |
| | 3 | 2 | |
| Stepped shape | 1 | 0 | 1.7 |
| | 2 | 1 | |
| | 3 | 0 | |

As shown in FIG. 3, it can be seen that when the air collection unit rib includes two rod-shaped portions each having a predetermined length and width and partially overlapping each other in the width direction (when the air collection unit rib had a stepped shape), the mosquito escape rate was lower than when the air collection unit rib includes one rod-shaped portion having a predetermined length and width (e.g., when the air collection unit rib had a rectangular shape).

Experimental Example 4—Control Over Light Output Under Dark Conditions

In order to confirm the effect of light output on mosquito collection efficiency under dark conditions, an experiment was conducted as follows:

Dark conditions: illuminance of ambient light detected by an illuminance sensor was 0 lux to 20 lux, or luminous intensity of ambient light detected by a UV sensor was 0 mW to 10 mW.

Test site: a 24 m² closed space

Duration of light radiation: 15 hours after the first light emitting module 15 was turned on

Target mosquito: 25 Culex pipiens pallens females

TABLE 4

| Light output of first | | Number of | Number of trapped | Trapping |
|---|---|---|---|---|
| light emitting module | | experiments | mosquitoes | rate (%) |
| 100 | mW | 1 | 20 | 80.0 |
| | | 2 | 16 | 64.0 |
| | | Average | — | 72.0 |
| | | Standard | — | 11.3 |
| | | deviation | | |
| 200 | mW | 1 | 21 | 84.0 |
| | | 2 | 18 | 72.0 |
| | | Average | — | 78.0 |
| | | Standard | — | 8.5 |
| | | deviation | | |
| 1000 | mW | 1 | 24 | 96.0 |
| | | 2 | 11 | 44.0 |
| | | Average | — | 70.0 |
| | | Standard | — | 36.8 |
| | | deviation | | |

As shown in FIG. 4, it can be seen that the intensity of light output from the first light emitting module, e.g., an insect attraction light source, had little effect on the mosquito trapping rate. More particularly, it was confirmed that there was little difference in mosquito trapping rate between light output of 100 mw and light output of 1000 mw. The insect trap according to an exemplary embodiment maintained high trapping efficiency with a low light output under dark conditions, and thus, could prevent dazzling due to insect attraction light and excessive energy consumption, unlike conventional insect traps.

Therefore, it was demonstrated through the experiments that the insect trap according to an exemplary embodiment allows light output of the first light emitting module to be manually controlled to be less than or equal to 100 mW by a user under dark conditions, or light output of the first light emitting module to be automatically controlled by the controller when the illuminance of ambient light detected by the illuminance sensor is less than or equal to 20 lux, thereby preventing dazzling due to insect attraction light and excessive energy consumption while maintaining high mosquito trapping efficiency, and also could increase lifespan and replacement interval of the first light emitting diode chip, thereby improving user friendliness.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. An insect trap, comprising:
a main body including a suction fan;
a first light emitting module mount disposed above the main body;
a first light emitting module disposed on the first light emitting module mount;
a roof disposed on the first light emitting module mount;
an insect collection unit disposed under the main body; and
an air collection unit disposed in the insect collection unit, the air collection unit having a substantially tapered shape to have a gradually decreasing diameter with an increasing distance from the suction fan,
wherein:
the first light emitting module mount comprises a first light emitting module cover facing at least a portion of the first light emitting module; and
the roof comprises a pressing portion protruding from the roof and contacting at least one of the first light emitting module and the first light emitting module cover.

2. The insect trap according to claim 1, wherein the air collection unit comprises at least two sections having different slopes along a vertical direction.

3. The insect trap according to claim 2, wherein the air collection unit comprises:
a plurality of air collection unit ribs; and
a plurality of air collection unit side openings formed between the air collection unit ribs through which air introduced into the insect trap by the suction fan pass therethrough.

4. The insect trap according to claim 3, wherein:
each of the air collection unit ribs comprises two rod-shaped portions each having a predetermined length and width, and partially overlapping each other in a width direction; and
an upper rod-shaped portion of one air collection unit rib is disposed adjacent to a lower rod-shaped portion of an adjacent air collection unit rib.

5. The insect trap according to claim 1, wherein the first light emitting module cover comprises:
a front surface;
a cover rim formed on at least one side of the front surface and having a greater thickness than the front surface; and
a protrusion protruding from the cover rim.

6. The insect trap according to claim 5, wherein the protrusion comprises:
a cover protrusion protruding from the cover rim and extending in a longitudinal direction of the first light emitting module cover; and
a cover step protruding from the cover rim and extending in a height direction of the first light emitting module cover, the cover protrusion and the cover step disposed on opposite surfaces of the first light emitting module cover, respectively.

7. The insect trap according to claim 6, wherein the first light emitting module mount comprises:
a first light emitting module insertion groove;
a cover insertion groove;
a cover step guide extending from the cover insertion groove toward the first light emitting module insertion groove; and
a cover protrusion guide extending from the cover insertion groove away from the first light emitting module insertion groove.

8. The insect trap according to claim 7, wherein the cover step guide and the cover protrusion guide form a step with the cover insertion groove disposed therebetween.

9. The insect trap according to claim 1, wherein the pressing portion further comprises a pressing portion protrusion protruding toward the first light emitting module cover, the pressing portion protrusion contacting the first light emitting module cover to press the first light emitting module cover in a direction from a surface of the first light emitting module cover on which the cover step is formed to a surface of the first light emitting module cover on which the cover protrusion is formed.

10. The insect trap according to claim 1, wherein:
the first light emitting module cover has an open surface for receiving the first light emitting module, at least one surface of the first light emitting module cover being transparent; and
the first light emitting module mount has an opening to which at least a portion of the first light emitting module cover is configured to be inserted, such that a seated portion of the first light emitting module cover is seated on an upper surface of the first light emitting module mount, and the roof is mounted on the first light emitting module mount and the first light emitting module cover.

11. An insect trap comprising:
a main body including a suction fan;
a first light emitting module mount disposed above the main body;
a first light emitting module disposed on the first light emitting module mount;
a second light emitting module mount disposed under the suction fan;
a second light emitting module disposed on the second light emitting module mount;
a photocatalyst filter disposed under the second light emitting module mount;
a roof disposed on the first light emitting module mount; and
an insect collection unit disposed under the main body,
wherein:
the first light emitting module mount comprises a first light emitting module cover facing at least a portion of the first light emitting module;
the roof comprises a pressing portion contacting at least one of the first light emitting module and the first light emitting module cover; and
the second light emitting module is configured to emit light toward the photocatalyst filter.

12. The insect trap according to claim 11, further comprising:
an air collection unit disposed under the main body and having a substantially tapered shape to have a gradually decreasing diameter with an increasing distance from the suction fan; and
a photocatalyst filter mount disposed under the second light emitting module mount and extending from the air collection unit.

13. The insect trap according to claim 12, further comprising a second protrusion extending from a lower side of the second light emitting module mount and surrounding at least a portion of the second light emitting module mount.

14. The insect trap according to claim 13, wherein:
the air collection unit comprises an air collection unit inlet, an air collection unit midsection, and an air collection unit outlet extending toward the insect collection unit; and
magnitudes of slope in a vertical direction decrease from the air collection unit outlet, the air collection unit inlet, and the air collection unit midsection.

15. An insect trap comprising:
a main body including a suction fan;
a first light emitting module mount disposed above the main body;
a first light emitting module disposed on the first light emitting module mount;
a roof disposed on the first light emitting module mount;
an insect collection unit disposed under the main body; and
a sensor unit comprising at least one of an illuminance sensor configured to detect illuminance of ambient light, a motion sensor configured to detect information on user's approach to the insect trap, and a UV sensor configured to detect information on luminous intensity of the first light emitting module,
wherein:
the first light emitting module mount comprises a first light emitting module cover facing at least a portion of the first light emitting module; and
the roof comprises a pressing portion contacting at least one of the first light emitting module and the first light emitting module cover.

16. The insect trap according to claim 15, wherein:
the information on user's approach to the insect trap comprises user's proximity to the insect trap; and
the first light emitting module is configured to reduce luminous intensity when the user's proximity to the insect trap is less than a predetermined value.

17. The insect trap according to claim 15, wherein:
the first light emitting module mount has a substantially plate-shape to mount the first light emitting module disposed at a lower surface thereof; and
the UV sensor is disposed on the lower surface of the first light emitting module mount, and is configured to be directly irradiated with light emitted from the first light emitting module and be shielded from light from the outside of the insect trap by the first light emitting module mount.

18. The insect trap according to claim 15, wherein:
the first light emitting module mount has a substantially plate-shape to mount the first light emitting module to be disposed at a lower surface thereof; and
the UV sensor is disposed on the first light emitting module, and is configured to be directly irradiated with light emitted from the first light emitting module and be shielded from light from the outside of the insect trap by the first light emitting module mount.

19. The insect trap according to claim 15, wherein the first light emitting module is configured to have light output less than or equal to about 100 mW, when illuminance of ambient light detected by the illuminance sensor is less than or equal to 20 lux.

20. The insect trap according to claim 15, wherein the first light emitting module is configured to have light output less than or equal to about 100 mW.
